(19) United States
(12) Patent Application Publication
(10) Pub. No.: US 2026/0227622 A1
(43) Pub. Date: Aug. 6, 2026

(54) EYEPIECE OPTICAL SYSTEM, OPTICAL APPARATUS, AND OBSERVATION METHOD

(71) Applicant: NIKON CORPORATION, Tokyo (JP)

(72) Inventor: Ayumu MAKIDA, Kawaguchi-shi (JP)

(21) Appl. No.: 19/576,574

(22) Filed: Mar. 24, 2026

Related U.S. Application Data
(63) Continuation of application No. PCT/JP2024/032623, filed on Sep. 12, 2024.

(30) Foreign Application Priority Data
Sep. 28, 2023 (JP) 2023-167619

(51) Int. Cl. G02B 23/14; G02B 3/00; G02B 7/02; G02B 9/62; G02B 13/00

(52) U.S. Cl. CPC G02B 23/14; G02B 7/025; G02B 9/62; G02B 13/0045; G02B 13/006; G02B 2003/0093

(57) ABSTRACT

An eyepiece optical system (EL) includes a first positive lens (Lp1) having a positive refractive power, and a second positive lens (Lp2) having a positive refractive power, and the following conditional expressions are satisfied,

$$1.7 < Np 1 < 2.05 , and$$

$$1.7 < Np 2 < 2.05 ,$$

where Np1: the refractive index of the first positive lens (Lp1) with respect to d-line, and
   Np2: the refractive index of the second positive lens (Lp2) with respect to d-line.

### TECHNICAL FIELD

The present invention relates to an eyepiece optical system that is suitable for an electronic viewfinder (what is called an EVF) and the like, and is for observing an image displayed on an image display element.

### TECHNICAL BACKGROUND

An eyepiece optical system that allows high-magnification observation of an image displayed on an image display element has been proposed (for example, see Patent literature 1). According to such an eyepiece optical system, it is difficult to correct various aberrations, in particular, astigmatism and distortion, and achieve a favorable optical performance.

### PRIOR ARTS LIST

### Patent Document

Patent literature 1: Japanese Laid-Open Patent Publication No. 2013-88632(A)

### SUMMARY OF THE INVENTION

An eyepiece optical system according to a first aspect of the present invention comprises: a first positive lens that has positive refractive power; and a second positive lens that has positive refractive power, wherein the following conditional expressions are satisfied,

$$1.7 < Np 1 < 2.05 , and$$

$$1.7 < Np 2 < 2.05 ,$$

where Np1: the refractive index of the first positive lens with respect to d-line, and
   Np2: the refractive index of the second positive lens with respect to d-line.

An eyepiece optical system according to a second aspect of the present invention comprises at least five lenses, wherein the following conditional expression is satisfied,

$$0.4 < h / fe < 0.5 ,$$

where fe: the combined focal length of the eyepiece optical system, and
   h: the maximum object height of an object to be observed for the eyepiece optical system.

An eyepiece optical system according to a third aspect of the present invention is an eyepiece optical system observing an image displayed on an image display element, the eyepiece optical system comprising at least five lenses.

An optical apparatus according to the present invention comprises: an objective lens; an image sensor configured to receive an image formed by the objective lens; an image display element configured to display the image acquired by the image sensor; and an eyepiece optical system for observing the image displayed on the image display element, wherein the eyepiece optical system is any of the eyepiece optical systems described above.

An observation method according to the present invention observes the object to be observed through any of the eyepiece optical systems described above.

### BRIEF DESCRIPTION OF THE DRAWINGS

FIG. 1 is a configuration diagram of an eyepiece optical system according to First Example;

FIG. 2 shows graphs of various aberrations of the eyepiece optical system with a diopter of −1 [m⁻¹] according to First Example;

FIG. 3 is a configuration diagram of an eyepiece optical system according to Second Example;

FIG. 4 shows graphs of various aberrations of the eyepiece optical system with a diopter of −1 [m⁻¹] according to Second Example;

FIG. 5 is a configuration diagram of an eyepiece optical system according to Third Example;

FIG. 6 shows graphs of various aberrations of the eyepiece optical system with a diopter of −1 [m⁻¹] according to Third Example;

FIG. 7 is a configuration diagram of an eyepiece optical system according to Fourth Example;

FIG. 8 shows graphs of various aberrations of the eyepiece optical system with a diopter of −1 [m⁻¹] according to Fourth Example;

FIG. 9 is a configuration diagram of an eyepiece optical system according to Fifth Example;

FIG. 10 shows graphs of various aberrations of the eyepiece optical system with a diopter of −1 [m⁻¹] according to Fifth Example;

FIG. 11 is a configuration diagram of an eyepiece optical system according to Sixth Example;

FIG. 12 shows graphs of various aberrations of the eyepiece optical system with a diopter of −1 [m⁻¹] according to Sixth Example;

FIG. 13 is a configuration diagram of an eyepiece optical system according to Seventh Example;

FIG. 14 shows graphs of various aberrations of the eyepiece optical system with a diopter of −1 [m⁻¹] according to Seventh Example; and

FIG. 15 is a sectional view of a digital camera.

### DESCRIPTION OF THE EMBODIMENTS

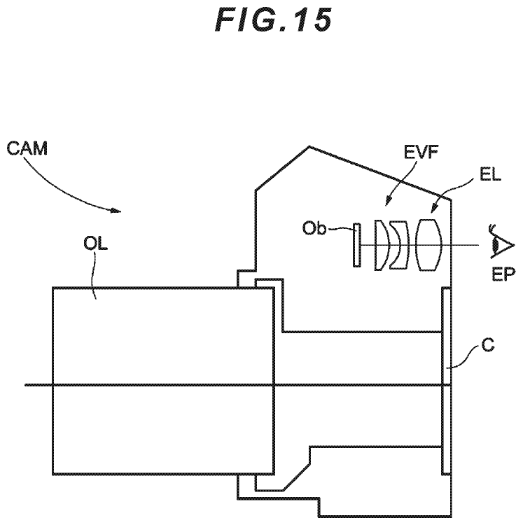

Preferred embodiments according to the present invention are described below. First, as an optical apparatus that includes an eyepiece optical system EL according to each embodiment, a digital camera CAM (optical apparatus) is shown in FIG. 15. The digital camera CAM has a configuration including: an objective lens OL; an image sensor C, such as a CCD or a CMOS, such as a CCD or a CMOS; and an electronic viewfinder EVF. The electronic viewfinder EVF has a configuration including: an image display element (observation object) Ob, such as a liquid crystal display element; and the eyepiece optical system EL for enlarging and observing an image displayed on the image display element Ob.

In the digital camera CAM having the above configuration, light from an object (subject) not shown is collected by the objective lens OL, and an image is formed on the image sensor C, thus forming the image of the subject. The image of the subject formed on the image sensor C is captured by the image sensor C, and the image of the subject captured by the image sensor C is displayed on the image display element Ob. A photographer positions an eye at the eye point EP, thereby allowing them to enlarge and observe the image of the object (subject) formed by the objective lens OL through the eyepiece optical system EL.

When a release button, not shown, is pressed by the photographer, the image captured by the image sensor C at the time (i.e., an image corresponding to the image that is displayed on the image display element Ob and is to be observed through the eyepiece optical system EL) is recorded as the image of the object (subject) in a memory, not shown. The photographer can thus take the image of the object (subject) by the digital camera CAM. The eyepiece optical system EL shown in FIG. 15 is a schematic illustration of the eyepiece optical system included in the digital camera CAM, and the lens configuration of the eyepiece optical system EL is not limited to this configuration.

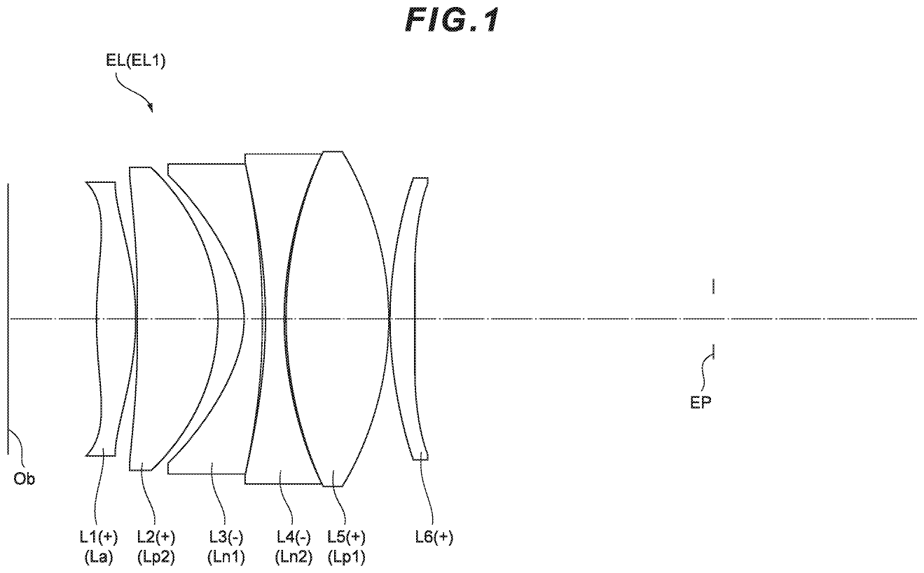

Next, an eyepiece optical system according to a first embodiment is described. As shown in FIG. 1, the eyepiece optical system EL (EL1) as an example of the eyepiece optical system EL according to the first embodiment includes: a first positive lens Lp1 that has positive refractive power; and a second positive lens Lp2 that has positive refractive power.

With the configuration described above, the eyepiece optical system EL according to the first embodiment satisfies the following conditional expressions (1) and (2).

$$1.7 < Np 1 < 2.05 \qquad ( 1 )$$

$$1.7 < Np 2 < 2.05 \qquad ( 2 )$$

where Np1: the refractive index of the first positive lens Lp1 with respect to d-line, and
   Np2: the refractive index of the second positive lens Lp2 with respect to d-line.

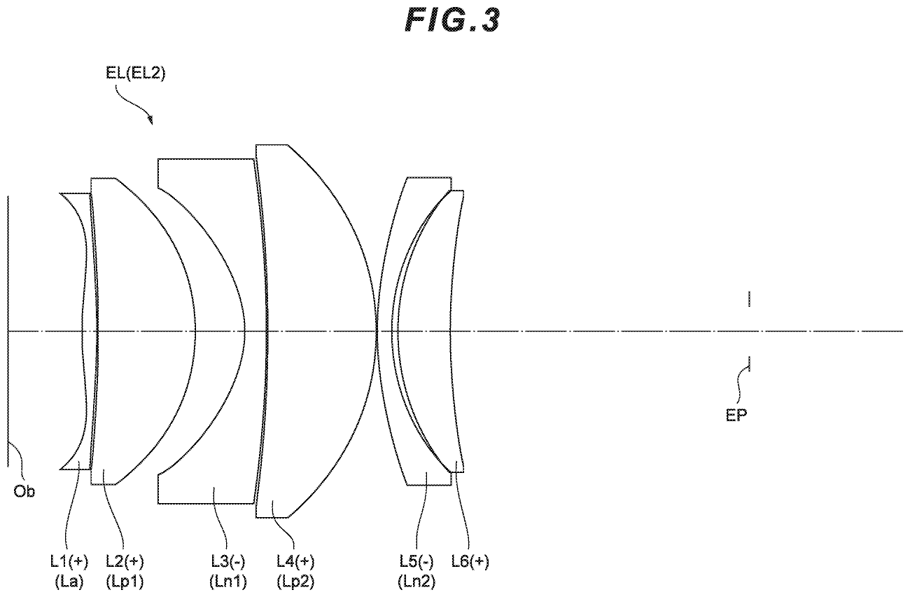

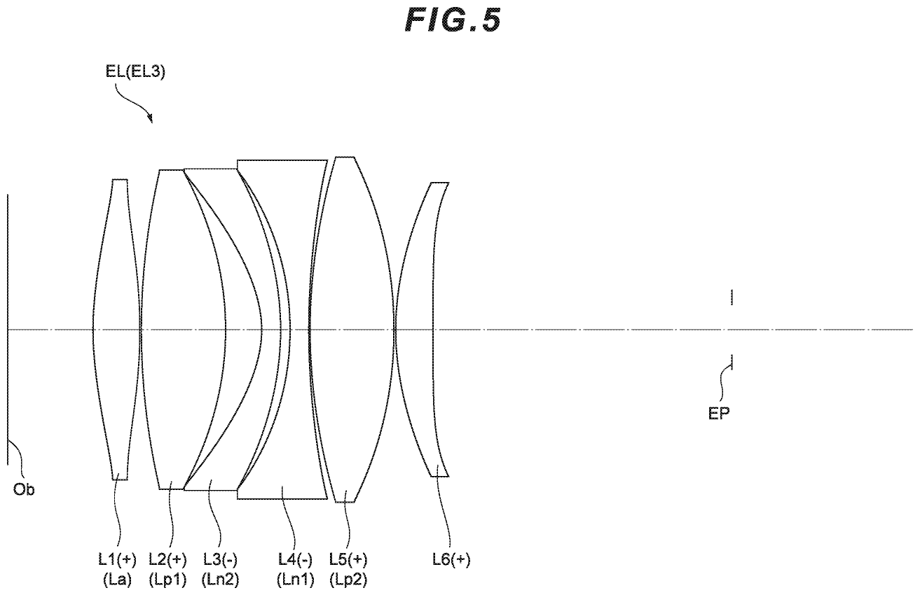

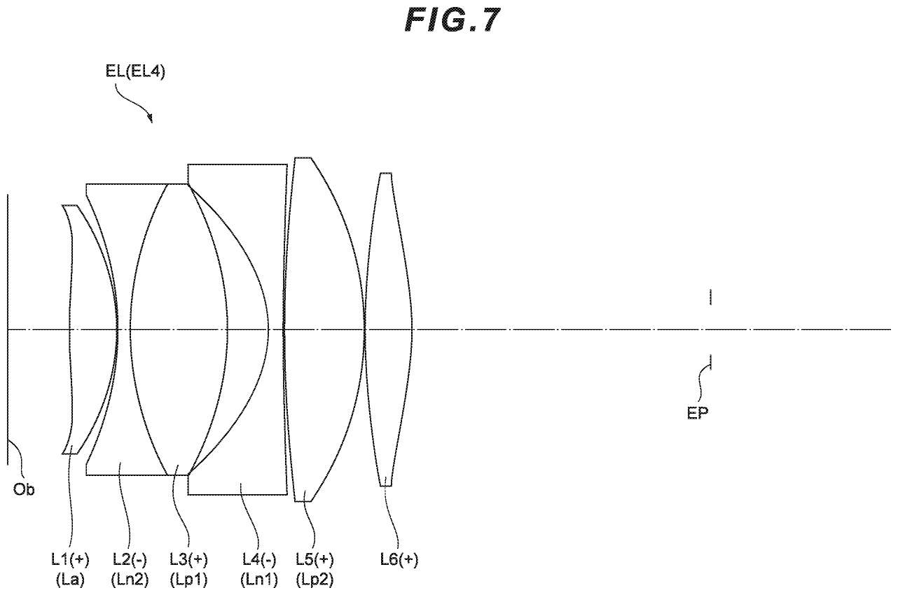

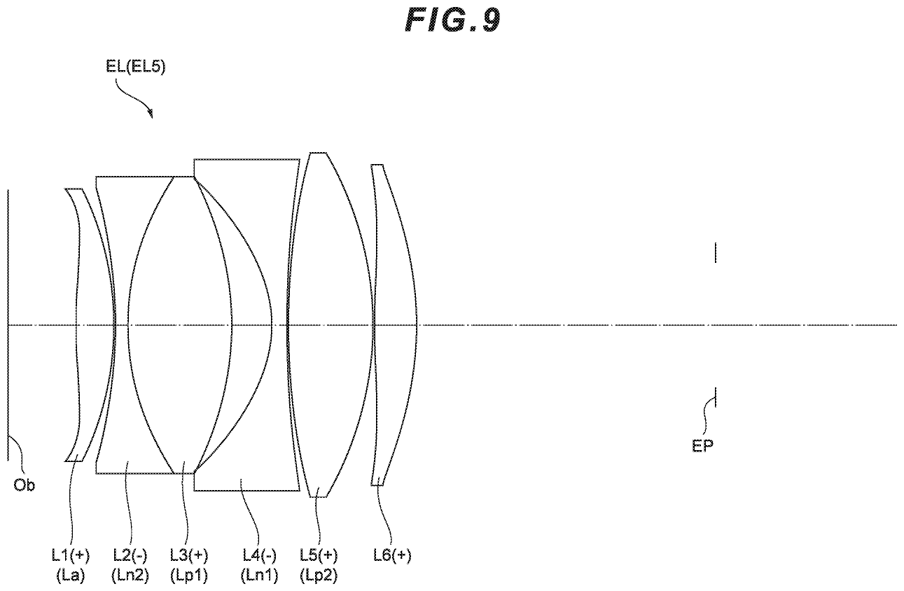

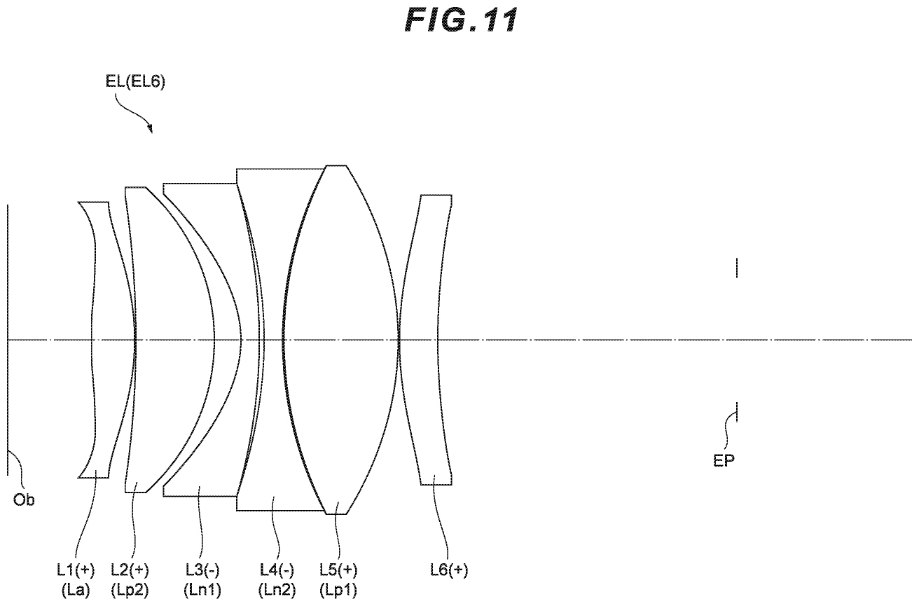

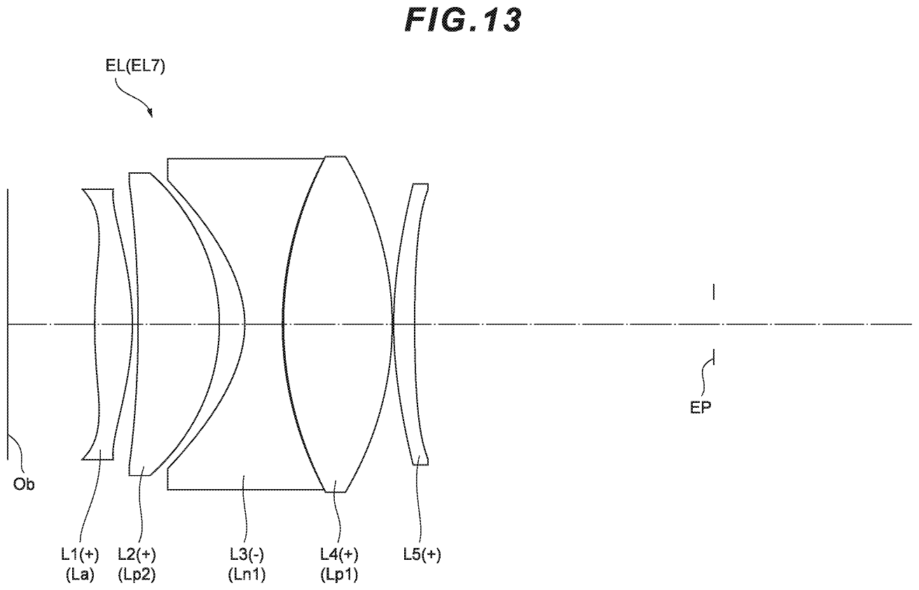

According to the first embodiment, the eyepiece optical system that has a favorable optical performance with various aberrations, in particular, astigmatism and distortion being corrected, and the optical apparatus that includes this eyepiece optical system can be obtained. A zoom optical system ZL according to the first embodiment may be an eyepiece optical system EL (EL2) shown in FIG. 3, an eyepiece optical system EL (EL3) shown in FIG. 5, an eyepiece optical system EL (EL4) shown in FIG. 7, an eyepiece optical system EL (EL5) shown in FIG. 9, an eyepiece optical system EL (EL6) shown in FIG. 11, or an eyepiece optical system EL (EL7) shown in FIG. 13.

The conditional expression (1) defines the refractive index of the first positive lens Lp1 with respect to d-line within an appropriate range. The positive lens Lp1 satisfies the conditional expression (1), which can favorably correct astigmatism.

If the corresponding value of the conditional expression (1) exceeds the upper limit value, the refractive index of the positive lens Lp1 increases, the Petzval sum is degraded, and it is difficult to correct the astigmatism. By setting the upper limit value of the conditional expression (1) to 1.960 and further to 1.890, the advantageous effects of the present embodiment can be further ensured.

If the corresponding value of the conditional expression (1) falls below the lower limit value, the refractive index of the positive lens Lp1 decreases, the Petzval sum is degraded, and it is difficult to correct the astigmatism. By setting the lower limit value of the conditional expression (1) to 1.750 and further to 1.810, the advantageous effects of the present embodiment can be further ensured.

The conditional expression (2) defines the refractive index of the second positive lens Lp2 with respect to d-line within an appropriate range. The positive lens Lp2 satisfies the conditional expression (2), which can favorably correct the astigmatism.

If the corresponding value of the conditional expression (2) exceeds the upper limit value, the refractive index of the positive lens Lp2 increases, the Petzval sum is degraded, and it is difficult to correct the astigmatism. By setting the upper limit value of the conditional expression (2) to 1.960 and further to 1.890, the advantageous effects of the present embodiment can be further ensured.

If the corresponding value of the conditional expression (2) falls below the lower limit value, the refractive index of the positive lens Lp2 decreases, the Petzval sum is degraded, and it is difficult to correct the astigmatism. By setting the lower limit value of the conditional expression (2) to 1.750 and further to 1.810, the advantageous effects of the present embodiment can be further ensured.

Desirably, in the eyepiece optical system EL according to the first embodiment, the first positive lens Lp1 has the highest positive refractive power in the eyepiece optical system EL, and the following conditional expression (3) is satisfied.

$$0.9 < Np 2 / Np 1 < 1.1 \qquad ( 3 )$$

The conditional expression (3) defines an appropriate relationship between the refractive index of the second positive lens Lp2 with respect to d-line, and the refractive index of the first positive lens Lp1 with respect to d-line. The conditional expression (3) is satisfied, which can favorably correct the astigmatism.

If the corresponding value of the conditional expression (3) exceeds the upper limit value, the refractive index at d-line of the first positive lens Lp1 having the highest positive refractive power becomes too low with respect to the second positive lens, the Petzval sum is degraded, and it is difficult to correct the astigmatism. By setting the upper limit value of the conditional expression (3) to 1.05 and further to 1.01, the advantageous effects of the present embodiment can be further ensured.

If the corresponding value of the conditional expression (3) falls below the lower limit value, the refractive index at d-line of the first positive lens Lp1 becomes too high with respect to the second positive lens, the Petzval sum is degraded, and it is difficult to correct the astigmatism. By setting the lower limit value of the conditional expression (3) to 0.92, 0.94, 0.95, and further to 0.96, the advantageous effects of the present embodiment can be further ensured.

Preferably, in the eyepiece optical system EL according to the first embodiment, the first positive lens Lp1 has the highest positive refractive power in the eyepiece optical system EL, and the following conditional expression (4) is satisfied.

$$0.7 < fLp 1 / fe < 1.3 \qquad ( 4 )$$

where fLp1: the focal length of the first positive lens Lp1, and
   fe: the combined focal length of the eyepiece optical system EL.

The conditional expression (4) defines an appropriate relationship between the focal length of the entire eyepiece optical system EL and the focal length of the first positive lens Lp1. By satisfying the conditional expression (4), curvature of field can be favorably corrected.

If the corresponding value of the conditional expression (4) exceeds the upper limit value, the refractive power of the first positive lens Lp1 decreases, the Petzval sum is degraded, and it is difficult to correct curvature of field. By setting the upper limit value of the conditional expression (4) to 1.28, 1.24, 1.22, 1.20, and further to 1.10, the advantageous effects of the present embodiment can be further ensured.

If the corresponding value of the conditional expression (4) falls below the lower limit value, the refractive power of the first positive lens Lp1 increases, the Petzval sum is degraded, and it is difficult to correct curvature of field. By setting the lower limit value of the conditional expression (4) to 0.720, 0.740, 0.750, 0.800, and further to 0.900, the advantageous effects of the present embodiment can be further ensured.

Preferably, in the eyepiece optical system EL according to the first embodiment, the second positive lens Lp2 has the second-highest positive refractive power in the eyepiece optical system EL, and the following conditional expression (5) is satisfied.

$$0.9 < fLp 2 / fe < 1.7 \qquad ( 5 )$$

where fLp2: the focal length of the second positive lens Lp2, and
   fe: the combined focal length of the eyepiece optical system EL.

The conditional expression (5) defines an appropriate relationship between the focal length of the entire eyepiece optical system EL and the focal length of the second positive lens Lp2. By satisfying the conditional expression (5), curvature of field can be favorably corrected.

If the corresponding value of the conditional expression (5) exceeds the upper limit value, the refractive power of the second positive lens Lp2 decreases, the Petzval sum is degraded, and it is difficult to correct curvature of field. By setting the upper limit value of the conditional expression (5) to 1.68, 1.58, 1.55, 1.35, and further to 1.30, the advantageous effects of the present embodiment can be further ensured.

If the corresponding value of the conditional expression (5) falls below the lower limit value, the refractive power of the second positive lens Lp2 increases, the Petzval sum is degraded, and it is difficult to correct curvature of field. By setting the lower limit value of the conditional expression (5) to 0.95, 1.00, and further to 1.10, the advantageous effects of the present embodiment can be further ensured.

Preferably, the eyepiece optical system EL according to the first embodiment further comprises a first negative lens Ln1 that has the highest negative refractive power in the eyepiece optical system EL, and the following conditional expressions (6) and (7) are satisfied.

$$1.5 < Nn 1 < 1.7 \qquad ( 6 )$$

$$16. < ν N 1 < 36. \qquad ( 7 )$$

where Nn1: the refractive index of the first negative lens Ln1 with respect to d-line, and
   νn1: the Abbe number of the first negative lens Ln1 with reference to d-line.

The conditional expression (6) defines the refractive index, at d-line, of the first negative lens Ln1, which has the highest negative refractive power in the eyepiece optical system EL, within an appropriate range. The negative lens Ln1 satisfies the conditional expression (6), which can favorably correct the astigmatism.

If the corresponding value of the conditional expression (6) exceeds the upper limit value, the refractive index of the negative lens Ln1 increases, the Petzval sum is degraded, and it is difficult to correct the astigmatism. By setting the upper limit value of the conditional expression (6) to 1.650 and further to 1.640, the advantageous effects of the present embodiment can be further ensured.

If the corresponding value of the conditional expression (6) falls below the lower limit value, the refractive index of the negative lens Ln1 decreases, the Petzval sum is degraded, and it is difficult to correct the astigmatism. By setting the lower limit value of the conditional expression (6) to 1.530, 1.550, and further to 1.600, the advantageous effects of the present embodiment can be further ensured.

The conditional expression (7) defines the Abbe number of the first negative lens Ln1, which has the highest negative refractive power in the eyepiece optical system EL, within an appropriate range. The Abbe number of the negative lens Ln1 satisfies the conditional expression (7), which can favorably correct the chromatic aberration.

If the corresponding value of the conditional expression (7) exceeds the upper limit value, it is not preferable because the dispersion due to the negative lens Ln1 decreases, and the correction of the chromatic aberration becomes insufficient. By setting the upper limit value of the conditional expression (7) to 30.000 and further to 25.000, the advantageous effects of the present embodiment can be further ensured.

If the corresponding value of the conditional expression (7) falls below the lower limit value, it is not preferable because the dispersion due to the negative lens Ln1 increases, and the correction of the chromatic aberration becomes excessive. By setting the lower limit value of the conditional expression (7) to 18.000 and further to 20.000, the advantageous effects of the present embodiment can be further ensured.

Preferably, the eyepiece optical system EL according to the first embodiment further comprises a second negative lens Ln2 that has the second-highest negative refractive power in the eyepiece optical system EL, and the following conditional expression (8) is satisfied.

$$1.5 < Nn 2 < 1.7 \qquad ( 8 )$$

where Nn2: the refractive index of the second negative lens Ln2 with respect to d-line.

The conditional expression (8) defines the refractive index, at d-line, of the second negative lens Ln2, which has the second-highest negative refractive power in the eyepiece optical system EL, within an appropriate range. The negative lens Ln2 satisfies the conditional expression (8), which can favorably correct the astigmatism.

If the corresponding value of the conditional expression (8) exceeds the upper limit value, the refractive index of the negative lens Ln2 increases, the Petzval sum is degraded, and it is difficult to correct the astigmatism. By setting the upper limit value of the conditional expression (8) to 1.650 and further to 1.640, the advantageous effects of the present embodiment can be further ensured.

If the corresponding value of the conditional expression (8) falls below the lower limit value, the refractive index of the negative lens Ln2 decreases, the Petzval sum is degraded, and it is difficult to correct the astigmatism. By setting the lower limit value of the conditional expression (8) to 1.530, 1.550, and further to 1.600, the advantageous effects of the present embodiment can be further ensured.

Preferably, the eyepiece optical system EL according to the first embodiment further comprises a first negative lens Ln1 that has the highest negative refractive power, and the following conditional expression (9) is satisfied.

$$8. < vp 1 - vn 1 < 35. \qquad ( 9 )$$

where νp1: the Abbe number of the first positive lens Lp1 with reference to d-line, and
   νn1: the Abbe number of the first negative lens Ln1 with reference to d-line.

The conditional expression (9) defines the difference between the Abbe numbers of the first positive lens Lp1 and the first negative lens Ln1 within an appropriate range. By satisfying the conditional expression (9), the chromatic aberration can be favorably corrected.

If the corresponding value of the conditional expression (9) exceeds the upper limit value, it is not preferable because the dispersion due to the negative lens Ln1 increases with respect to the first positive lens Lp1, and the correction of the chromatic aberration becomes excessive. By setting the upper limit value of the conditional expression (9) to 30.000 and further to 25.000, the advantageous effects of the present embodiment can be further ensured.

If the corresponding value of the conditional expression (9) falls below the lower limit value, it is not preferable because the dispersion due to the negative lens Ln1 decreases with respect to the first positive lens Lp1, and the correction of the chromatic aberration becomes insufficient. By setting the lower limit value of the conditional expression (9) to 10.000, 12.000, 15.000, and further to 20.000, the advantageous effects of the present embodiment can be further ensured.

Preferably, the eyepiece optical system EL according to the first embodiment further comprises a first negative lens Ln1 that has the highest negative refractive power, and the following conditional expression (10) is satisfied.

$$8. < vp 2 - vn 1 < 35. \qquad ( 10 )$$

where νp2: the Abbe number of the second positive lens Lp2 with reference to d-line, and
   νn1: the Abbe number of the first negative lens Ln1 with reference to d-line.

The conditional expression (10) defines the difference between the Abbe numbers of the second positive lens Lp2 and the first negative lens Ln1 within an appropriate range. By satisfying the conditional expression (10), the chromatic aberration can be favorably corrected.

If the corresponding value of the conditional expression (10) exceeds the upper limit value, it is not preferable because the dispersion due to the negative lens Ln1 increases with respect to the second positive lens Lp2, and the correction of the chromatic aberration becomes excessive. By setting the upper limit value of the conditional expression (10) to 30.000 and further to 25.000, the advantageous effects of the present embodiment can be further ensured.

If the corresponding value of the conditional expression (10) falls below the lower limit value, it is not preferable because the dispersion due to the negative lens Ln1 decreases with respect to the second positive lens Lp2, and the correction of the chromatic aberration becomes insufficient. By setting the lower limit value of the conditional expression (10) to 10.000, 12.000, 15.000, and further to 20.000, the advantageous effects of the present embodiment can be further ensured.

Preferably, the eyepiece optical system EL according to the first embodiment satisfies the following conditional expression (11).

$$0.4 < h / fe < 0.5 \qquad ( 11 )$$

where fe: the combined focal length of the eyepiece optical system EL, and
   h: the maximum object height of an object Ob to be observed in the eyepiece optical system EL.

The conditional expression (11) defines the size of an image obtained by the eyepiece optical system EL using the maximum object height of the object Ob to be observed with respect to the focal length of the entire eyepiece optical system EL. By satisfying the conditional expression (11), the various aberrations can be favorably corrected even with a large field of view.

If the corresponding value of the conditional expression (11) exceeds the upper limit value, it is not preferable because the field of view becomes too large and it is difficult to correct the off-axis aberration. By setting the upper limit value of the conditional expression (11) to 0.480, 0.470, 0.460, and further to 0.450, the advantageous effects of the present embodiment can be further ensured.

If the corresponding value of the conditional expression (11) falls below the lower limit value, the magnification of the eyepiece optical system EL increases, and it is difficult to correct various aberrations. By setting the lower limit value of the conditional expression (11) to 0.420, 0.430, and further to 0.440, the advantageous effects of the present embodiment can be further ensured.

Preferably, the eyepiece optical system EL according to the first embodiment further comprises one or more lenses having lens surfaces on which aspherical surfaces are formed, wherein the following conditional expression (12) is satisfied.

$$0. \leq Daspe / ΣD < 0.2 \qquad ( 12 )$$

where Daspe: the distance on the optical axis from an aspherical surface that is closest to the eye point among the aspherical surfaces to a lens surface of the eyepiece optical system EL that is closest to the eye point, and
   ΣD: the distance on the optical axis from a lens surface that is closest to an object Ob to be observed to the lens surface that is closest to the eye point EP.

The conditional expression (12) defines the ratio between the distance on the optical axis from the aspherical surface closest to the eye point EP to the lens surface closest to the eye point EP, and the distance between the lens surface closest to the object Ob to be observed to the lens surface closest to the eye point EP, within an appropriate range. By satisfying the conditional expression (12), spherical aberration and coma aberration that occur on the eye point EP side can be favorably corrected.

If the corresponding value of the conditional expression (12) exceeds the upper limit value, it is difficult to correct spherical aberration and coma aberration that occur on the eye point EP side because the position of the aspherical surface disposed closest to the eye point EP is away from the eye point EP. By setting the upper limit value of the conditional expression (12) to 0.190 and further to 0.170, the advantageous effects of the present embodiment can be further ensured. Note that the lower limit value of the conditional expression (12) represents the lens surface closest to the eye point EP.

Preferably, the eyepiece optical system EL according to the first embodiment further comprises one or more lenses having lens surfaces on which aspherical surfaces are formed, wherein the following conditional expression (13) is satisfied.

$$0. \leq Daspo / ΣD < 0.2 \qquad ( 13 )$$

where Daspo: the distance on the optical axis from a lens surface of the eyepiece optical system EL that is closest to an object Ob to be observed to an aspherical surface that is closest to the object Ob to be observed among the aspherical surfaces, and
   ΣD: the distance on the optical axis from the lens surface that is closest to the object Ob to be observed to the lens surface that is closest to the eye point EP.

The conditional expression (13) defines the ratio between the distance on the optical axis from the lens surface closest to the object Ob to be observed to the aspherical surface closest to the object Ob to be observed, and the distance between the lens surface closest to the object Ob to be observed to the lens surface closest to the eye point EP, within an appropriate range. By satisfying the conditional expression (13), the distortion of the eyepiece optical system EL that occurs on the object-Ob-to-be-observed side can be favorably corrected.

If the corresponding value of the conditional expression (13) exceeds the upper limit value, it is difficult to correct distortion that occurs on the object-Ob-to-be-observed side because the position of the aspherical surface disposed closest to the object Ob to be observed is away from the object Ob to be observed. By setting the upper limit value of the conditional expression (13) to 0.190 and further to 0.170, the advantageous effects of the present embodiment can be further ensured. Note that the lower limit value 0.000 of the conditional expression (13) represents the lens surface closest to the object Ob to be observed.

Preferably, the eyepiece optical system EL according to the first embodiment further comprises at least one lens La having a lens surface on which an aspherical surface is formed, the aspherical surface being provided with an inflection point at which a curvature is inverted from positive to negative or negative to positive, wherein the following conditional expression (14) is satisfied.

$$0.2 < y / Ry < 0.85 \qquad ( 14 )$$

where y: the distance between the optical axis of the lens La and the inflection point in a direction perpendicular to the optical axis, and
   Ry: the radius of the lens La.

The conditional expression (14) defines the ratio between the distance between the optical axis and the position of the inflection point on the lens La in the direction perpendicular to the optical axis, and the radius of the lens La within an appropriate range. By satisfying the conditional expression (14), the inflection point is provided at a peripheral portion of the optical axis in the effective diameter of the lens La, and the distortion can be favorably corrected by the inflection point. The inflection point is at the position where the curvature is inverted, and the curvature is inverted from positive to negative or negative to positive at this point as a boundary. Desirably, the lens that has the aspherical surface closest to the object Ob to be observed among the aspherical surfaces is configured as the lens La provided with the inflection point. With such a configuration, the distortion can be favorably corrected. Furthermore, by configuring the lens La as the lens that has positive refractive power paraxially and has the inflection point therearound, which can improve the telecentricity on the object-Ob-to-be-observed side.

If the corresponding value of the conditional expression (14) exceeds the upper limit value, it is not preferable because the distortion at the intermediate image height is degraded. By setting the upper limit value of the conditional expression (14) to 0.700 and further to 0.500, the advantageous effects of the present embodiment can be further ensured.

If the corresponding value of the conditional expression (14) falls below the lower limit value, it is not preferable because curvature of field is degraded. By setting the lower limit value of the conditional expression (14) to 0.250 and further to 0.300, the advantageous effects of the present embodiment can be further ensured.

Preferably, the eyepiece optical system EL according to the first embodiment includes at least five lenses. With such a configuration, the various aberrations can be favorably corrected. If the number of lenses is four or less, the refractive power of each of the lenses increases, and it is difficult to correct aberrations.

Preferably, in the eyepiece optical system EL according to the first embodiment, both the first positive lens Lp1 and the second positive lens Lp2 are lenses that have lens surfaces formed as spherical surfaces. By forming the lens surfaces of the positive lens Lp1 and the positive lens Lp2 as spherical surfaces, the performance degradation due to eccentricity can be reduced. The performance degradation due to an aspherical surface shape error, which largely affects a lens with a high refractive index, can be avoided.

Next, an eyepiece optical system according to a second embodiment is described. An eyepiece optical system EL (EL1) that is an example of the eyepiece optical system EL according to the second embodiment includes at least five lenses as shown in FIG. 1.

With the configuration described above, the eyepiece optical system EL according to the second embodiment satisfies the following conditional expression (11).

$$0.4 < h / fe < 0.5 \qquad ( 11 )$$

where fe: the combined focal length of the eyepiece optical system EL, and
   h: the maximum object height of an object Ob to be observed in the eyepiece optical system EL.

According to the second embodiment, the eyepiece optical system that has a favorable optical performance with various aberrations, in particular, astigmatism and distortion being corrected, and the optical apparatus that includes this eyepiece optical system can be obtained. A zoom optical system ZL according to the second embodiment may be an eyepiece optical system EL (EL2) shown in FIG. 3, an eyepiece optical system EL (EL3) shown in FIG. 5, an eyepiece optical system EL (EL4) shown in FIG. 7, an eyepiece optical system EL (EL5) shown in FIG. 9, an eyepiece optical system EL (EL6) shown in FIG. 11, or an eyepiece optical system EL (EL7) shown in FIG. 13.

The eyepiece optical system EL has the configuration with at least five lenses, which can favorably correct various aberrations. If the number of lenses is four or less, the refractive power of each of the lenses increases, and it is difficult to correct aberrations.

The conditional expression (11) is an expression similar to that in the first embodiment, and can achieve similar advantageous effects. If the corresponding value of the conditional expression (11) exceeds the upper limit value, it is not preferable because the field of view becomes too large and it is difficult to correct the off-axis aberration. By setting the upper limit value of the conditional expression (11) to 0.480, 0.470, 0.460, and further to 0.450, the advantageous effects of the present embodiment can be further ensured.

If the corresponding value of the conditional expression (11) falls below the lower limit value, the magnification of the eyepiece optical system EL increases, and it is difficult to correct various aberrations. By setting the lower limit value of the conditional expression (11) to 0.420, 0.430, and further to 0.440, the advantageous effects of the present embodiment can be further ensured.

Preferably, the eyepiece optical system EL according to the second embodiment satisfies the following conditional expression (11).

$$0.4 < h / fe < 0.5 \qquad ( 11 )$$

where fe: the combined focal length of the eyepiece optical system EL, and
   h: the maximum object height of an object Ob to be observed in the eyepiece optical system EL.

The conditional expression (11) is an expression similar to that in the first embodiment, and can achieve similar advantageous effects. If the corresponding value of the conditional expression (11) exceeds the upper limit value, it is not preferable because the field of view becomes too large and it is difficult to correct the off-axis aberration. By setting the upper limit value of the conditional expression (11) to 0.480, 0.470, 0.460, and further to 0.450, the advantageous effects of the present embodiment can be further ensured.

If the corresponding value of the conditional expression (11) falls below the lower limit value, the magnification of the eyepiece optical system EL increases, and it is difficult to correct various aberrations. By setting the lower limit value of the conditional expression (11) to 0.420, 0.430, and further to 0.440, the advantageous effects of the present embodiment can be further ensured.

Preferably, the eyepiece optical system EL according to the second embodiment further comprises one or more lenses having lens surfaces on which aspherical surfaces are formed, wherein the following conditional expression (12) is satisfied.

$$0. \leq Daspe / ΣD < 0.2 \qquad ( 12 )$$

where Daspe: the distance on the optical axis from an aspherical surface that is closest to the eye point among the aspherical surfaces to a lens surface of the eyepiece optical system EL that is closest to the eye point, and
   ΣD: the distance on the optical axis from a lens surface that is closest to an object Ob to be observed to the lens surface that is closest to the eye point EP.

The conditional expression (12) is an expression similar to that in the first embodiment, and can achieve similar advantageous effects. By satisfying the conditional expression (12), spherical aberration and coma aberration that occur on the eye point EP side can be favorably corrected by the aspherical surfaces.

If the corresponding value of the conditional expression (12) exceeds the upper limit value, it is difficult to correct spherical aberration and coma aberration that occur on the eye point EP side because the position of the aspherical surface disposed closest to the eye point EP is away from the eye point EP. By setting the upper limit value of the conditional expression (12) to 0.190 and further to 0.170, the advantageous effects of the present embodiment can be further ensured. Note that the lower limit value of the conditional expression (12) represents the lens surface closest to the eye point EP.

Preferably, the eyepiece optical system EL according to the second embodiment further comprises one or more lenses having lens surfaces on which aspherical surfaces are formed, wherein the following conditional expression (13) is satisfied.

$$0. \leq Daspo / ΣD < 0.2 \qquad ( 13 )$$

where Daspo: the distance on the optical axis from a lens surface of the eyepiece optical system EL that is closest to an object Ob to be observed to an aspherical surface that is closest to the object Ob to be observed among the aspherical surfaces, and
   ΣD: the distance on the optical axis from a lens surface that is closest to an object Ob to be observed to the lens surface that is closest to the eye point EP.

The conditional expression (13) is an expression similar to that in the first embodiment, and can achieve similar advantageous effects. By satisfying the conditional expression (13), the distortion of the eyepiece optical system EL that occurs on the object-Ob-to-be-observed side can be favorably corrected.

If the corresponding value of the conditional expression (13) exceeds the upper limit value, it is difficult to correct distortion that occurs on the object-Ob-to-be-observed side because the position of the aspherical surface disposed closest to the object Ob to be observed is away from the object Ob to be observed. By setting the upper limit value of the conditional expression (13) to 0.190 and further to 0.170, the advantageous effects of the present embodiment can be further ensured. Note that the lower limit value of the conditional expression (13) represents the lens surface closest to the object Ob to be observed.

Preferably, the eyepiece optical system EL according to the second embodiment further comprises at least one lens La having a lens surface on which an aspherical surface is formed, the aspherical surface being provided with an inflection point at which a curvature is inverted from positive to negative or negative to positive, wherein the following conditional expression (14) is satisfied.

$$0.2 < y / Ry < 0.85 \qquad ( 14 )$$

where y: the distance between the optical axis of the lens La and the inflection point in a direction perpendicular to the optical axis, and
   Ry: the radius of the lens La.

The conditional expression (14) is an expression similar to that in the first embodiment, and can achieve similar advantageous effects. By satisfying the conditional expression (14), the inflection point is provided at a peripheral portion of the optical axis in the effective diameter of the lens La, and the distortion can be favorably corrected by the inflection point. The inflection point is at the position where the curvature is inverted, and the curvature is inverted from positive to negative or negative to positive at this point as a boundary. Desirably, the lens that has the aspherical surface closest to the object Ob to be observed among the aspherical surfaces is configured as the lens La provided with the inflection point. With such a configuration, the distortion can be favorably corrected. Furthermore, by configuring the lens La as the lens that has positive refractive power paraxially and has the inflection point therearound, which can improve the telecentricity on the object-Ob-to-be-observed side.

If the corresponding value of the conditional expression (14) exceeds the upper limit value, it is not preferable because the distortion at the intermediate image height is degraded. By setting the upper limit value of the conditional expression (14) to 0.700 and further to 0.500, the advantageous effects of the present embodiment can be further ensured.

If the corresponding value of the conditional expression (14) falls below the lower limit value, it is not preferable because curvature of field is degraded. By setting the lower limit value of the conditional expression (14) to 0.250 and further to 0.300, the advantageous effects of the present embodiment can be further ensured.

Preferably, the eyepiece optical system EL according to the second embodiment includes at least five lenses. With such a configuration, the various aberrations can be favorably corrected. If the number of lenses is four or less, the refractive power of each of the lenses increases, and it is difficult to correct aberrations.

Next, an eyepiece optical system according to a third embodiment is described. An eyepiece optical system EL (EL1) that is an example of the eyepiece optical system EL according to the third embodiment is an eyepiece optical system that is for observing an image displayed on the image display element, and has at least five lenses, as shown in FIGS. 1 and 15.

According to the third embodiment, the eyepiece optical system that has a favorable optical performance with various aberrations, in particular, astigmatism and distortion being corrected, and the optical apparatus that includes this eyepiece optical system can be obtained. A zoom optical system ZL according to the second embodiment may be an eyepiece optical system EL (EL2) shown in FIG. 3, an eyepiece optical system EL (EL3) shown in FIG. 5, an eyepiece optical system EL (EL4) shown in FIG. 7, an eyepiece optical system EL (EL5) shown in FIG. 9, an eyepiece optical system EL (EL6) shown in FIG. 11, or an eyepiece optical system EL (EL7) shown in FIG. 13.

The eyepiece optical system EL has the configuration with at least five lenses, which can favorably correct various aberrations. If the number of lenses is four or less, the refractive power of each of the lenses increases, and it is difficult to correct aberrations.

Preferably, the eyepiece optical system EL according to the third embodiment satisfies the following conditional expression (11).

$$0.4 < h / fe < 0.5 \qquad ( 11 )$$

where fe: the combined focal length of the eyepiece optical system EL, and
   h: the maximum object height of an object Ob to be observed in the eyepiece optical system EL.

The conditional expression (11) is an expression similar to that in the first and second embodiments, and can achieve similar advantageous effects. By satisfying the conditional expression (11), the various aberrations can be favorably corrected even with a large field of view.

If the corresponding value of the conditional expression (11) exceeds the upper limit value, it is not preferable because the field of view becomes too large and it is difficult to correct the off-axis aberration. By setting the upper limit value of the conditional expression (11) to 0.480, 0.470, 0.460, and further to 0.450, the advantageous effects of the present embodiment can be further ensured.

If the corresponding value of the conditional expression (11) falls below the lower limit value, the magnification of the eyepiece optical system EL increases, and it is difficult to correct various aberrations. By setting the lower limit value of the conditional expression (11) to 0.420, 0.430, and further to 0.440, the advantageous effects of the present embodiment can be further ensured.

Preferably, the eyepiece optical system EL according to the third embodiment further comprises one or more lenses having lens surfaces on which aspherical surfaces are formed, wherein the following conditional expression (12) is satisfied.

$$0. \leq Daspe / ΣD < 0.2 \qquad ( 12 )$$

where Daspe: the distance on the optical axis from an aspherical surface that is closest to the eye point among the aspherical surfaces to a lens surface of the eyepiece optical system EL that is closest to the eye point, and
   ΣD: the distance on the optical axis from a lens surface that is closest to an object Ob to be observed to the lens surface that is closest to the eye point EP.

The conditional expression (12) is an expression similar to that in the first and second embodiments, and can achieve similar advantageous effects. By satisfying the conditional expression (12), spherical aberration and coma aberration that occur on the eye point EP side can be favorably corrected by the aspherical surfaces.

If the corresponding value of the conditional expression (12) exceeds the upper limit value, it is difficult to correct spherical aberration and coma aberration that occur on the eye point EP side because the position of the aspherical surface disposed closest to the eye point EP is away from the eye point EP. By setting the upper limit value of the conditional expression (12) to 0.190 and further to 0.170, the advantageous effects of the present embodiment can be further ensured. Note that the lower limit value of the conditional expression (12) represents the lens surface closest to the eye point EP.

Preferably, the eyepiece optical system EL according to the third embodiment further comprises one or more lenses having lens surfaces on which aspherical surfaces are formed, wherein the following conditional expression (13) is satisfied.

$$0. \leq Daspo / ΣD < 0.2 \qquad ( 13 )$$

where Daspo: the distance on the optical axis from a lens surface of the eyepiece optical system EL that is closest to an object Ob to be observed to an aspherical surface that is closest to the object Ob to be observed among the aspherical surfaces, and
   ΣD: the distance on the optical axis from a lens surface that is closest to an object Ob to be observed to the lens surface that is closest to the eye point EP.

The conditional expression (13) is an expression similar to that in the first and second embodiments, and can achieve similar advantageous effects. By satisfying the conditional expression (13), the distortion of the eyepiece optical system EL that occurs on the object-Ob-to-be-observed side can be favorably corrected.

If the corresponding value of the conditional expression (13) exceeds the upper limit value, it is difficult to correct distortion that occurs on the object-Ob-to-be-observed side because the position of the aspherical surface disposed closest to the object Ob to be observed is away from the object Ob to be observed. By setting the upper limit value of the conditional expression (13) to 0.190 and further to 0.170, the advantageous effects of the present embodiment can be further ensured. Note that the lower limit value of the conditional expression (13) represents the lens surface closest to the object Ob to be observed.

Preferably, the eyepiece optical system EL according to the third embodiment further comprises at least one lens La having a lens surface on which an aspherical surface is formed, the aspherical surface being provided with an inflection point at which a curvature is inverted from positive to negative or negative to positive, wherein the following conditional expression (14) is satisfied.

$$0. 20 < y / Ry < 0 \text{.85} \qquad ( 14 )$$

where y: the distance between the optical axis of the lens La and the inflection point in a direction perpendicular to the optical axis, and
   Ry: the radius of the lens La

The conditional expression (14) is an expression similar to that in the first and second embodiments, and can achieve similar advantageous effects. By satisfying the conditional expression (14), the inflection point is provided at a peripheral portion of the optical axis in the effective diameter of the lens La, and the distortion can be favorably corrected by the inflection point. The inflection point is at the position where the curvature radius is inverted, and the curvature is inverted from positive to negative or negative to positive at this point as a boundary. Desirably, the lens that has the aspherical surface closest to the object Ob to be observed among the aspherical surfaces is configured as the lens La provided with the inflection point. With such a configuration, the distortion can be favorably corrected. Furthermore, by configuring the lens La as the lens that has positive refractive power paraxially and has the inflection point therearound, which can improve the telecentricity on the object-Ob-to-be-observed side.

If the corresponding value of the conditional expression (14) exceeds the upper limit value, it is not preferable because the distortion at the intermediate image height is degraded. By setting the upper limit value of the conditional expression (14) to 0.700 and further to 0.500, the advantageous effects of the present embodiment can be further ensured.

If the corresponding value of the conditional expression (14) falls below the lower limit value, it is not preferable because curvature of field is degraded. By setting the lower limit value of the conditional expression (14) to 0.250 and further to 0.300, the advantageous effects of the present embodiment can be further ensured.

Preferably, the eyepiece optical systems EL according to the first to third embodiments satisfy the following conditional expression (15).

$$20. [ mm ] < De < 30. [ mm ] \qquad ( 15 )$$

where De: the distance on the optical axis to the eye point EP from a lens surface of the eyepiece optical system EL that is closest to the eye point EP.

The conditional expression (15) defines the distance on the optical axis to the eye point EP from the lens surface of the eyepiece optical system EL that is closest to the eye point EP. By satisfying the conditional expression (15), various aberrations, such as distortion, spherical aberration, and coma aberration, can be favorably corrected.

If the corresponding value of the conditional expression (15) exceeds the upper limit value, it is not preferable because the convex lens having high positive refractive power is disposed at a position apart from the aperture stop disposed outside the eyepiece optical system EL, and it is difficult to correct distortion. By setting the upper limit value of the conditional expression (15) to 28.000 and further to 26.000, the advantageous effects of the present embodiment can be further ensured.

If the corresponding value of the conditional expression (15) falls below the lower limit value, it is not preferable because the separation between the axial light flux and the paraxial light flux on the eye point EP side decreases and it is difficult to correct spherical aberration and coma aberration. By setting the lower limit value of the conditional expression (15) to 21.000 and further to 22.000, the advantageous effects of the present embodiment can be further ensured.

Preferably, the eyepiece optical systems EL according to the first to third embodiments satisfy the following conditional expression (16).

$$1.1 < De / fe < 1.5 \qquad ( 16 )$$

where De: the distance on the optical axis to the eye point EP from a lens surface of the eyepiece optical system EL that is closest to the eye point EP, and
   fe: the combined focal length of the eyepiece optical system EL.

The conditional expression (16) defines the ratio between the distance on the optical axis to the eye point EP from the lens surface of the eyepiece optical system EL that is closest to the eye point EP, and the focal length of the entire eyepiece optical system EL, within an appropriate range. By satisfying the conditional expression (16), various aberrations, such as distortion, spherical aberration, and coma aberration, can be favorably corrected.

If the corresponding value of the conditional expression (16) exceeds the upper limit value, it is not preferable because the convex lens having high positive refractive power is disposed at a position apart from the aperture stop disposed outside the eyepiece optical system EL, and it is difficult to correct distortion. By setting the upper limit value of the conditional expression (16) to 1.450, 1.400, and further to 1.350, the advantageous effects of the present embodiment can be further ensured.

If the corresponding value of the conditional expression (16) falls below the lower limit value, it is not preferable because the separation between the axial light flux and the paraxial light flux on the eye point EP side decreases and it is difficult to correct spherical aberration and coma aberration. By setting the lower limit value of the conditional expression (16) to 1.200, 1.240, 1.280, and further to 1.300, the advantageous effects of the present embodiment can be further ensured.

Preferably, in the eyepiece optical systems EL according to the first to third embodiments described above, the lens disposed closest to the object Ob to be observed has positive refractive power. With such a configuration, the distortion can be favorably corrected. If a lens having negative refractive power is disposed closest to the object Ob to be observed, the size of the lens in the radial direction increases, which is not preferable.

Preferably, the eyepiece optical systems EL according to the first to third embodiments satisfy the following conditional expression (17).

$$0.25 < D 0 / fe < 0.5 \qquad ( 17 )$$

where D0: the distance on the optical axis from an object Ob to be observed to a lens surface closest to the object Ob to be observed, with a diopter of 0 [m⁻¹], and
   fe: the combined focal length of the eyepiece optical system EL.

The conditional expression (17) defines the ratio between the distance on the optical axis from the object Ob to be observed to the lens surface closest to the object Ob to be observed and the focal length of the entire eyepiece optical system EL with a diopter of 0 [m⁻¹], within an appropriate range. By satisfying the conditional expression (17), various aberrations, such as curvature of field and distortion, can be favorably corrected, and the telecentricity on the object-Ob-to-be-observed side can be maintained.

If the corresponding value of the conditional expression (17) exceeds the upper limit value, it is difficult to correct curvature of field and distortion because the lens surface closest to the object Ob to be observed is away from the object Ob to be observed. By setting the upper limit value of the conditional expression (17) to 0.480, 0.460, 0.440, and further to 0.420, the advantageous effects of the present embodiment can be further ensured.

If the corresponding value of the conditional expression (17) falls below the lower limit value, it is not preferable because the lens surface closest to the object Ob to be observed is too close to the object Ob to be observed, and the telecentricity on the object-Ob-to-be-observed side is degraded accordingly. By setting the lower limit value of the conditional expression (17) to 0.300, 0.350, and further to 0.400, the advantageous effects of the present embodiment can be further ensured.

Preferably, the eyepiece optical systems EL according to the first to third embodiments satisfy the following conditional expression (18).

$$0.12 < D 0 / TL < 0.2 \; 50 \qquad ( 18 )$$

where D0: the distance on the optical axis from the object Ob to be observed to the lens surface closest to the object Ob to be observed, with a diopter of 0 [m⁻¹], and
   TL: the distance on the optical axis from the object Ob to be observed to a lens surface closest to the eye point EP, with a diopter of 0 [m⁻¹].

The conditional expression (18) defines the ratio between the distance on the optical axis from the object Ob to be observed to the lens surface closest to the object Ob to be observed with a diopter of 0 [m⁻¹], and the distance on the optical axis from the object Ob to be observed to the lens surface closest to the eye point EP with a diopter of 0 [m⁻¹], within an appropriate range. By satisfying the conditional expression (18), various aberrations, such as curvature of field and distortion, can be favorably corrected, and the telecentricity on the object-Ob-to-be-observed side can be maintained.

If the corresponding value of the conditional expression (18) exceeds the upper limit value, it is difficult to correct curvature of field and distortion because the lens surface closest to the object Ob to be observed is away from the object Ob to be observed. By setting the upper limit value of the conditional expression (18) to 0.240 and further to 0.230, the advantageous effects of the present embodiment can be further ensured.

If the corresponding value of the conditional expression (18) falls below the lower limit value, it is not preferable because the lens surface closest to the object Ob to be observed is too close to the object Ob to be observed, and the telecentricity on the object-Ob-to-be-observed side is degraded accordingly. By setting the lower limit value of the conditional expression (18) to 0.125, 0.150, and further to 0.200, the advantageous effects of the present embodiment can be further ensured.

Preferably, the eyepiece optical systems EL according to the first to third embodiments satisfy the following conditional expression (19).

$$0.08 < \sum Dair / \sum D < 0.2 \; 00 \qquad ( 19 )$$

where ΣDair: the sum of air distances between lenses from the lens closest to the object Ob to be observed to the lens closest to the eye point EP, and
   ΣD: the distance on the optical axis from the lens surface that is closest to the object Ob to be observed to the lens surface that is closest to the eye point EP.

The conditional expression (19) defines the ratio between the sum of air distances between lenses from the lens closest to the object Ob to be observed to the lens closest to the eye point EP, and the distance on the optical axis from the lens surface closest to the object Ob to be observed to the lens surface closest to the eye point EP, within an appropriate range. By satisfying the conditional expression (19), various aberrations can be favorably corrected. Note that an optical element that has no refractive power, such as a prism, may be employed before and/or after the eyepiece optical system EL. In a case of employing an optical element having no refractive power, such as a prism, it is preferable that ΣDair be an air equivalent length from the lens closest to the object Ob to be observed to the lens closest to the eye point EP. That is, ΣDair is an air equivalent length that includes the optical element having no refractive power, such as a prism.

If the corresponding value of the conditional expression (19) exceeds the upper limit value, the distances between the lenses increase, and it is difficult to correct various aberrations. By setting the upper limit value of the conditional expression (19) to 0.180, 0.170, 0.160, and further to 0.150, the advantageous effects of the present embodiment can be further ensured.

If the corresponding value of the conditional expression (19) falls below the lower limit value, the difference between the curvature radii of a convex surface and a concave surface of adjacent lenses is required to be small, and it is difficult to correct aberrations on the convex surface and the concave surface. By setting the lower limit value of the conditional expression (19) to 0.085, 0.090, 0.100, and further to 0.110, the advantageous effects of the present embodiment can be further ensured.

Preferably, in the eyepiece optical systems EL according to the first to third embodiments described above, the lens disposed closest to the object Ob to be observed has positive refractive power, and a lens disposed closer to the eye point than, and adjacent to, the lens closest to the object to be observed has positive refractive power. Such a configuration facilitates simultaneous correction of distortion and spherical aberration.

Preferably, in the eyepiece optical systems EL according to the first to third embodiments, the number of lenses having positive refractive power is four. With such a configuration, the refractive power of the convexity of each lens can be low, thereby making the correction of various aberrations favorable.

Preferably, the eyepiece optical systems EL according to the first to third embodiments satisfy the following conditional expression (20).

$$1. < f 1 / fe < 2 \text{.50} \qquad ( 20 )$$

where f1: the focal length of the lens disposed closest to the object to be observed, and
   fe: the combined focal length of the eyepiece optical system.

The conditional expression (20) defines the ratio between the focal length of the lens disposed closest to the object to be observed and the focal length of the entire eyepiece optical system EL within an appropriate range. By satisfying the conditional expression (20), various aberrations can be favorably corrected.

If the corresponding value of the conditional expression (20) exceeds the upper limit value, the positive refractive power of the lens closest to the object to be observed decreases, and the distortion is degraded accordingly, and it is difficult to correct the aberration. By setting the upper limit value of the conditional expression (20) to 2.00, 2.10, and further to 2.30, the advantageous effects of the present embodiment can be further ensured.

If the corresponding value of the conditional expression (20) falls below the lower limit value, the positive refractive power of the lens closest to the object to be observed increases, and curvature of field is degraded accordingly, and it is difficult to correct the aberration. By setting the lower limit value of the conditional expression (20) to 1.10, 1.20, and further to 1.25, the advantageous effects of the present embodiment can be further ensured.

Preferably, the eyepiece optical systems EL according to the first to third embodiments satisfy the following conditional expression (21).

$$1.5 < fep / fe < 5 \text{.00} \qquad ( 21 )$$

where fep: the focal length of the lens disposed closest to the eye point, and
   fe: the combined focal length of the eyepiece optical system.

The conditional expression (21) defines the ratio between the focal length of the lens disposed closest to the eye point and the focal length of the entire eyepiece optical system EL within an appropriate range. By satisfying the conditional expression (21), various aberrations can be favorably corrected.

If the corresponding value of the conditional expression (21) exceeds the upper limit value, it is difficult to increase the observation magnification while maintaining curvature of field because the positive refractive power of the lens closest to the eye point decreases. By setting the upper limit value of the conditional expression (21) to 4.10, 4.20, and further to 4.30, the advantageous effects of the present embodiment can be further ensured.

If the corresponding value of the conditional expression (21) falls below the lower limit value, the positive refractive power of the lens closest to the eye point increases, and spherical aberration and coma aberration are degraded accordingly, and it is difficult to correct the aberration. By setting the lower limit value of the conditional expression (21) to 1.60, 1.65, and further to 1.70, the advantageous effects of the present embodiment can be further ensured.

According to the present embodiment described above, the eyepiece optical system that has a favorable optical performance with various aberrations, in particular, astigmatism and distortion being corrected, and the optical apparatus that includes this eyepiece optical system can be obtained.

### EXAMPLES

Eyepiece optical systems EL according to Examples of the present embodiment are described below with reference to the drawings. FIGS. 1, 3, 5, 7, 9, 11, and 13 are sectional views showing the configurations and refractive power allocation of the eyepiece optical systems EL {EL(1) to EL(7)} according to First to Seventh Examples. In these diagrams (FIGS. 1, 3, 5, 7, 9, and 13), each lens is represented by a combination of a symbol L and a numeral. In this case, to prevent the number of types of symbols, and the numerals from increasing to cause complication, each lens group or the like is represented using a combination of a symbol and a numeral independently with respect to each Example. Accordingly, even when the same combination of a symbol and a numeral is used across Examples, it does not indicate the same configuration. The sign (+) or (−) assigned to each lens group indicates the refractive power of the corresponding lens group, and this similarly applies to all the Examples.

While Tables 1 to 7 are shown below, among them, Table 1 is a table showing data items in First Example, Table 2 is a table showing those in Second Example, Table 3 is a table showing those in Third Example, Table 4 is a table showing those in Fourth Example, Table 5 is a table showing those in Fifth Example, Table 6 is a table showing those in Sixth Example, and Table 7 is a table showing those in Seventh Example. In each Example, d-line (wavelength λ=587.6 nm) and g-line (wavelength λ=435.8 nm) are selected for calculation targets of aberration characteristics.

In [General Data] in the table, fe indicates the focal length of the entire eyepiece optical system EL, TL indicates the entire length of the eyepiece optical system EL (the distance on the optical axis from the surface of the object Ob to be observed to the lens surface closest to the eye point EP with a diopter of 0 [m⁻¹]), ΣD indicates the distance on the optical axis from the lens surface closest to the object Ob to be observed to the lens surface closest to the eye point EP, ΣDair indicates the sum of air distances between lenses from the lens closest to the object Ob to be observed to the lens closest to the eye point EP, Daspe indicates the distance on the optical axis from the lens surface closest to the object Ob to be observed to the aspherical surface closest to the object Ob to be observed among the aspherical surface in the eyepiece optical system EL, Daspo indicates the distance on the optical axis from the lens surface closest to the object Ob to be observed to the aspherical surface closest to the object Ob to be observed among the aspherical surfaces in the eyepiece optical system EL, Np1 indicates the refractive index of the first positive lens Lp1 with respect to d-line, Np2 indicates the refractive index of the second positive lens Lp2 with respect to d-line, Nn1 indicates the refractive index of the first negative lens Ln1 with respect to d-line, Nn2 indicates the refractive index of the second negative lens Ln2 with respect to d-line, fLp1 indicates the focal length of the first positive lens Lp1, fLp2 indicates the focal length of the second positive lens Lp2, νp1 indicates the Abbe number of the first positive lens Lp1 with reference to d-line, νp2 indicates the Abbe number of the second positive lens Lp2 with reference to d-line, and νn1 indicates the Abbe number of the first negative lens Ln1 with reference to d-line.

In [Lens Data] in the table, Surface Number indicates the order of the optical surfaces from the object-Ob-to-be-observed side along the direction in which the light beam travels, r indicates the curvature radius of each optical surface, D indicates the surface distance that is the distance on the optical axis from each optical surface to the next optical surface (or the eye point EP), νd indicates the Abbe number of the material of the lens with reference to d-line, nd indicates the refractive index of the material of the lens with respect to d-line, “∞” in the field of Curvature Radius r indicates a flat surface, and EP indicates the eye point. The refractive index of air “1.0000” is omitted. When the optical surface is an aspherical surface, Surface Number is assigned a symbol of *, and the field of Curvature Radius r indicates the paraxial radius of curvature.

[Aspherical Surface Data] in the table represents the shape of the aspherical surface indicated in [Lens Data] with the following Expression (a). X(y) indicates the distance along the optical axis direction from the tangent plane at the vertex of the aspherical surface to the position on the aspherical surface at a height of y, r indicates the curvature radius of the reference spherical surface (paraxial radius of curvature), K indicates the conic constant, and Ai indicates the i-th order aspherical coefficient. “E-n” indicates “×10⁻ⁿ”. For example, 1.234E-05=1.234×10⁻⁵.

$$X ( y ) = ( {y}^{2} / r ) / \{ 1 + {( 1 - κ \cdot {y}^{2} / {r}^{2} )}^{1 / 2} \} + A 4 \times {y}^{4} + A 6 \times {y}^{6} + A 8 \times {y}^{8} \qquad ( a )$$

[Variable Distance Data] indicates the changes of D0 and De that are shown in [Lens Data] and are changed by diopter adjustment. D0 indicates the distance on the optical axis from the surface of the object Ob to be observed to the lens surface closest to object to be observed with an diopter of 0 [m⁻¹], De indicates the distance on the optical axis to the eye point EP from the lens surface closest to the eye point EP in the eyepiece optical system EL, and TL indicates the entire length of the eyepiece optical system EL (the distance on the optical axis from the surface of the object Ob to be observed to the lens surface closest to the eye point EP with a diopter of 0 [m⁻¹]). As the unit of the diopter, “m⁻¹” is used. The diopter of X “m⁻¹” indicates a state where an image by the eyepiece optical system EL can be disposed at a position at 1/X [m (meter)] on the optical axis from the eye point EP (note that the sign is positive when the image is formed closer to the observer than the eyepiece optical system EL).

Hereinafter, while with respect to all the data items, “mm” is generally used for the listed focal length f, curvature radius r, surface distance D, other length and the like unless otherwise noted, there is no limitation to this because similar optical performances can be achieved even with proportional expansion or proportional contraction of the optical system. The unit is not limited to “mm”, and another appropriate unit may be used.

The description of the tables so far is common to all Examples, and redundant description below is omitted.

### First Example

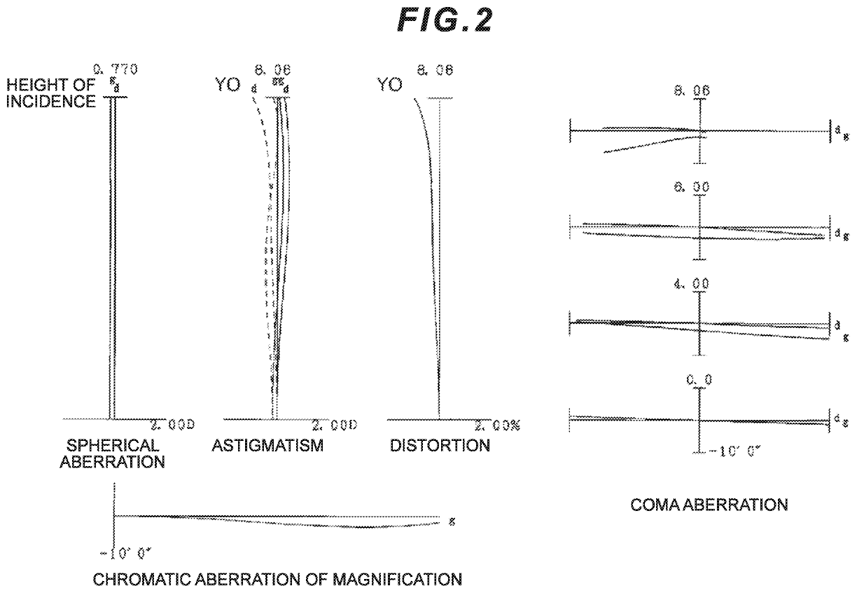

First Example is described with reference to FIGS. 1 and 2, and Table 1. As shown in FIG. 1, an eyepiece optical system EL (EL1) according to First Example includes, in order from an object to be observed (image display element) Ob on the optical axis: a first lens L1 that has positive refractive power; a second lens L2 that has positive refractive power; a third lens L3 that has negative refractive power; a fourth lens that has negative refractive power; a fifth lens that has positive refractive power; and a sixth lens that has positive refractive power.

The first lens L1 is a biconvex positive lens. The lens surfaces of the first lens on the object-Ob-to-be-observed side and the eye point EP side are formed as aspherical surfaces. On each aspherical surface, an inflection point at which the curvature changes from positive to negative or negative to positive is provided at a peripheral portion in the effective diameter.

The second lens L2 is a meniscus-shaped positive lens having a concave surface facing the object Ob to be observed.

The third lens L3 is a meniscus-shaped negative lens having a concave surface facing the object Ob to be observed. The lens surface of the third lens L3 on the object-Ob-to-be-observed side is formed as an aspherical surface.

The fourth lens L4 is a biconcave negative lens. The lens surface of the fourth lens L4 on the object-Ob-to-be-observed side is formed as an aspherical surface.

The fifth lens L5 is a biconvex positive lens.

The sixth lens L6 is a meniscus-shaped positive lens having a convex surface facing the object Ob to be observed. The lens surfaces on the opposite sides of the sixth lens L6 are formed as aspherical surfaces.

The diopter is adjusted by the first lens L1 to the sixth lens L6 integrally moving on the optical axis.

In the present example, the fifth lens L5 constitutes the first positive lens Lp1, and the second lens L2 constitutes the second positive lens Lp2. The third lens L3 constitutes the first negative lens Ln1, and the fourth lens L4 constitutes the second negative lens Ln2. The first lens L1 constitutes the lens La that has an inflection point on an aspherical surface. The lens disposed closest to the object to be observed is the first lens L1, and the lens disposed closest to the eye point is the sixth lens L6.

The following Table 1 shows values of data in First Example. Surface Number in Table 1 corresponds to each optical surface in FIG. 1. In First Example, the first surface, second surface, fifth surface, seventh surface, eleventh surface, and twelfth surface are formed to have aspherical shapes.

Note that each reference symbol in FIG. 1 is independently used on an example-by-example basis in order to prevent the description from being complicated by increase in the number of digits or characters of each reference symbol. Accordingly, even if reference symbols that are common to those in diagrams in other examples are assigned, the components are not necessarily common to those in the other examples.

TABLE 1
[General Data]

| | |
|---|---|
| fe = 18.206 | TL = 32.965 |
| ΣD = 25.542 | ΣDair = 2.734 |
| Daspe = 0.000 | Daspo = 0.000 |
| Np1 = 1.883 | Np2 = 1.883 |
| Nn1 = 1.636 | Nn2 = 1.636 |
| fLp1 = 17.416 | fLp2 = 21.203 |
| νp1 = 40.69 | νp2 = 40.69 |
| νn1 = 23.89 | |

[Lens Data]

| Surface | | | | |
|---|---|---|---|---|
| number | r | D | νd | nd |
| | ∞ | D0 | | |
| *1 | 30.7477 | 3.155 | 55.71 | 1.535037 |
| *2 | −24.1080 | 0.160 | | |
| 3 | −107.4267 | 6.441 | 40.69 | 1.883000 |
| 4 | −16.3916 | 2.097 | | |
| *5 | −9.1203 | 1.500 | 23.89 | 1.635500 |
| 6 | −56.4844 | 0.236 | | |
| *7 | −40.4146 | 1.500 | 23.89 | 1.635500 |
| 8 | 30.6024 | 0.140 | | |
| 9 | 31.9528 | 8.245 | 40.69 | 1.883000 |
| 10 | −26.0603 | 0.100 | | |
| *11 | 31.5758 | 1.967 | 55.71 | 1.535037 |
| *12 | 469.9409 | De | | |
| EP | | | | |

[Aspherical surface data]
1st surface
K = 1.0000, A4 = −1.78550E−04, A6 = 5.97416E−07, A8 = −6.09944E−09
2nd surface
K = 1.0000, A4 = 1.47007E−05, A6 = 4.44177E−07, A8 = 0.00000E+00
5^{th} surface
K = 0.3948, A4 = 1.94090E−04, A6 = −3.70012E−07, A8 = 1.57181E−09
7^{th} surface
K = 0.1447, A4 = 8.58992E−06, A6 = 2.97567E−08, A8 = 0.00000E+00
11^{th} surface
K = 1.0000, A4 = −3.37528E−05, A6 = 2.22950E−07, A8 = −4.76586E−10
12^{th} surface
K = 1.0000, A4 = 5.89071E−05, A6 = 6.30686E−08, A8 = 0.00000E+00
[Variable distance data]

| diopter | −1[m⁻¹] | 0[m⁻¹] | −4[m⁻¹] | +2[m⁻¹] |
|---|---|---|---|---|
| D0 | 7.0862 | 7.4231 | 6.0049 | 8.0651 |
| De | 24.0000 | 23.7810 | 24.8220 | 23.4050 |

[Lens group data]

| | |
|---|---|
| f1 | 25.773 |
| f2 | 21.203 |
| f3 | −17.328 |
| F4 | −27.181 |
| f5 | 17.416 |
| f6 | 63.168 |

The table of data listed in Table 1 shows that the eyepiece optical system EL1 according to First Example satisfies the conditional expressions (1) to (21).

FIG. 2 illustrates graphs showing various aberrations (spherical aberration, astigmatism, coma aberration, distortion, and chromatic aberration of magnification) of the eyepiece optical system EL1 according to First Example with a diopter of −1 [m⁻¹].

In each aberration graph, the ordinate axis of the spherical aberration graph indicates the height of incidence of light from the optical axis center of the object Ob to be observed, on the tangent plane of the lens surface of the first lens L1 on the object-Ob-to-be-observed side in the eyepiece optical system EL1, and the ordinate axis YO of each of the astigmatism graph and the distortion graph indicates the size (radius) of the object Ob to be observed. d indicates an aberration curve at d-line, and g indicates that at g-line. What has no indication represents an aberration curve at d-line. In the astigmatism graph, a solid line indicates a sagittal image surface, and a broken line indicates a meridional image surface. In the aberration graph showing coma aberration, meridional coma is indicated. In the spherical aberration graph and the astigmatism graph, the unit of the abscissa axis is [m⁻¹], and is indicated with “D.” in the graphs.

The above description of the aberration graphs is similar to that in the other examples, and the description thereof is omitted.

As is evident from each aberration graph shown in FIG. 2, it is shown that with the eyepiece optical system EL1 according to First Example, various aberrations, in particular, astigmatism and distortion, are favorably corrected, and the excellent optical performance is ensured.

### Second Example

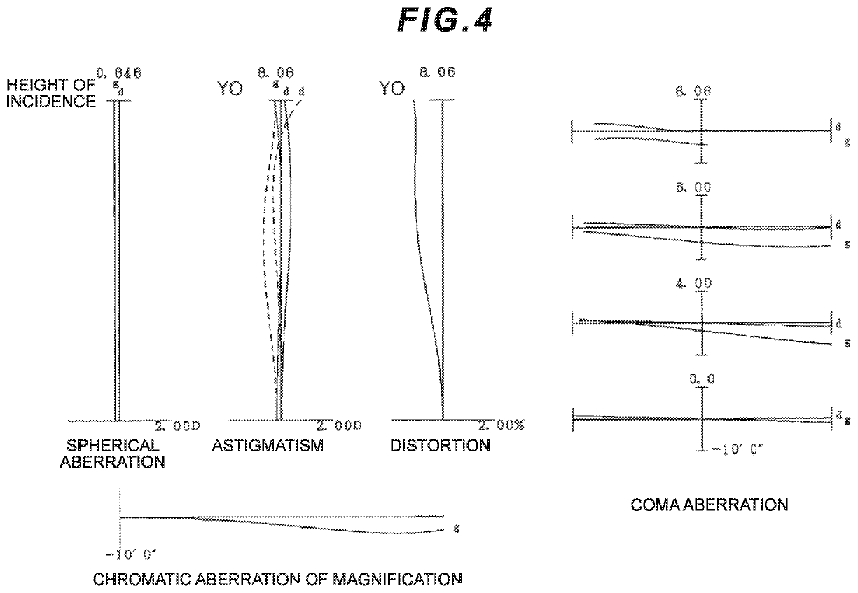

Second Example is described with reference to FIGS. 3 and 4, and Table 2. As shown in FIG. 3, an eyepiece optical system EL (EL2) according to Second Example includes, in order from an object to be observed (image display element) Ob on the optical axis: a first lens L1 that has positive refractive power; a second lens L2 that has positive refractive power; a third lens L3 that has negative refractive power; a fourth lens that has positive refractive power; a fifth lens that has negative refractive power; and a sixth lens that has positive refractive power.

The first lens L1 is a biconvex positive lens. The lens surfaces on the opposite sides of the first lens L1 are formed as aspherical surfaces. On each aspherical surface, an inflection point at which the curvature changes from positive to negative or negative to positive is provided at a peripheral portion in the effective diameter.

The second lens L2 is a meniscus-shaped positive lens having a concave surface facing the object Ob to be observed.

The third lens L3 is a meniscus-shaped negative lens having a concave surface facing the object Ob to be observed. The lens surface of the third lens L3 on the object-Ob-to-be-observed side is formed as an aspherical surface.

The fourth lens L4 is a meniscus-shaped positive lens having a concave surface facing the object Ob to be observed.

The fifth lens L5 is a meniscus-shaped negative lens having a convex surface facing the object Ob to be observed. The lens surfaces on the opposite sides of the fifth lens L5 are formed as aspherical surfaces.

The sixth lens L6 is a meniscus-shaped positive lens having a convex surface facing the object Ob to be observed.

The diopter is adjusted by the first lens L1 to the sixth lens L6 integrally moving on the optical axis.

In the present example, the second lens L2 constitutes the first positive lens Lp1, and the fourth lens L4 constitutes the second positive lens Lp2. The third lens L3 constitutes the first negative lens Ln1, and the fifth lens L5 constitutes the second negative lens Ln2. The first lens L1 constitutes the lens La that has an inflection point on an aspherical surface. The lens disposed closest to the object to be observed is the first lens L1, and the lens disposed closest to the eye point is the sixth lens L6.

The following Table 2 shows values of data in Second Example. Surface Number in Table 2 corresponds to each optical surface in FIG. 3. In Second Example, the first surface, second surface, fifth surface, ninth surface, and tenth surface are formed to have aspherical shapes.

TABLE 2
[General Data]

| | |
|---|---|
| fe = 18.148 | TL = 35.861 |
| ΣD = 29.587 | ΣDair = 4.744 |
| Daspe = 4.681 | Daspo = 0.000 |
| Np1 = 1.816 | Np2 = 1.816 |
| Nn1 = 1.636 | Nn2 = 1.636 |
| fLp1 = 20.474 | fLp2 = 27.613 |
| νp1 = 46.59 | νp2 = 46.59 |
| νn1 = 23.89 | |

[Lens Data]

| Surface | | | | |
|---|---|---|---|---|
| number | r | D | νd | nd |
| | ∞ | D0 | | |
| *1 | 26.5711 | 1.206 | 55.71 | 1.535037 |
| *2 | −62.7078 | 0.100 | | |
| 3 | −107.6728 | 7.800 | 46.59 | 1.816000 |
| 4 | −14.9332 | 3.970 | | |
| *5 | −9.1205 | 1.756 | 23.89 | 1.635500 |
| 6 | −91.0615 | 0.100 | | |
| 7 | −104.3286 | 8.692 | 46.59 | 1.816000 |
| 8 | −19.2237 | 0.100 | | |
| *9 | 26.0438 | 1.183 | 23.89 | 1.635500 |
| *10 | 16.6161 | 0.473 | | |
| 11 | 17.5952 | 4.207 | 47.35 | 1.788000 |
| 12 | 56.4147 | De | | |
| EP | | | | |

[Aspherical surface data]
1st surface
K = 1.0000, A4 = −2.42203E−04, A6 = −8.43861E−08, A8 = −1.44518E−09
2nd surface
K = 1.0000, A4 = 3.45500E−05, A6 = −5.75821E−08, A8 = 0.00000E+00
5th surface
K = 0.5205, A4 = 2.24960E−04, A6 = −5.18571E−07, A8 = 1.83367E−09
9th surface
K = 1.0000, A4 = −6.26763E−05, A6 = 2.15008E−07, A8 = 0.00000E+00
10th surface
K = 1.0000, A4 = 5.85286E−06, A6 = 9.69503E−08, A8 = 0.00000E+00
[Variable distance data]

| diopter | −1[m⁻¹] | 0[m⁻¹] | −4[m⁻¹] | +2[m⁻¹] |
|---|---|---|---|---|
| D0 | 5.9387 | 6.2746 | 4.8462 | 6.9086 |
| De | 24.0000 | 23.6970 | 25.1110 | 23.1660 |

[Lens group data]

| | |
|---|---|
| f1 | 35.047 |
| f2 | 20.474 |
| f3 | −16.083 |
| f4 | 27.613 |
| f5 | −75.932 |
| f6 | 30.970 |

The table of data listed in Table 2 shows that the eyepiece optical system EL2 according to Second Example satisfies the conditional expressions (1) to (21).

FIG. 4 illustrates graphs showing various aberrations (spherical aberration, astigmatism, coma aberration, distortion, and chromatic aberration of magnification) of the eyepiece optical system EL2 according to Second Example with a diopter of −1 [m⁻¹].

As is evident from each aberration graph shown in FIG. 4, it is shown that with the eyepiece optical system EL2 according to Second Example, various aberrations, in particular, astigmatism and distortion, are favorably corrected, and the excellent optical performance is ensured.

### Third Example

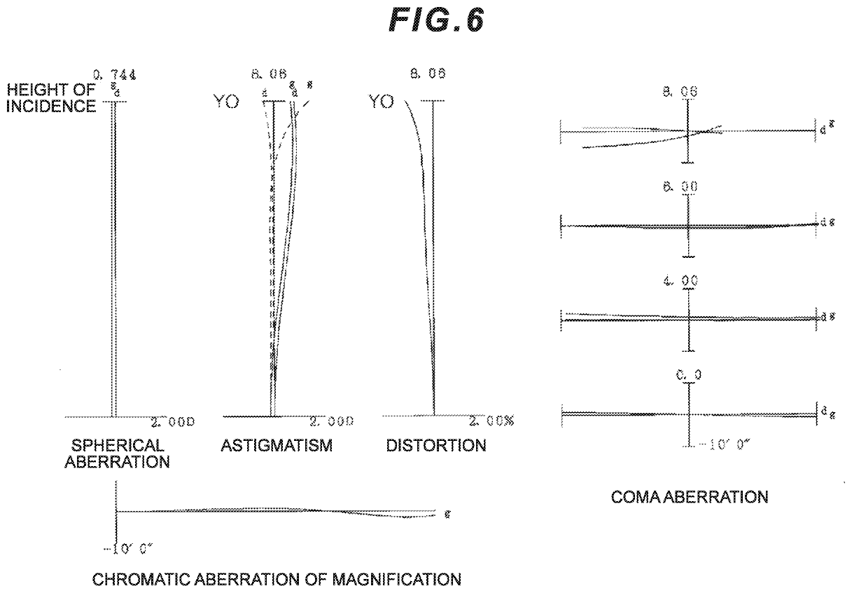

Third Example is described with reference to FIGS. 5 and 6, and Table 3. As shown in FIG. 5, an eyepiece optical system EL (EL3) according to Third Example includes, in order from an object to be observed (image display element) Ob on the optical axis: a first lens L1 that has positive refractive power; a second lens L2 that has positive refractive power; a third lens L3 that has negative refractive power; a fourth lens that has negative refractive power; a fifth lens that has positive refractive power; and a sixth lens that has positive refractive power.

The first lens L1 is a biconvex positive lens. The lens surfaces of the first lens on the object-Ob-to-be-observed side and the eye point EP side are formed as aspherical surfaces. On each aspherical surface, an inflection point at which the curvature changes from positive to negative or negative to positive is provided at a peripheral portion in the effective diameter.

The second lens L2 is a biconvex positive lens.

The third lens L3 is a meniscus-shaped negative lens having a concave surface facing the object Ob to be observed. The lens surface of the third lens L3 on the object-Ob-to-be-observed side is formed as an aspherical surface.

The fourth lens L4 is a biconcave negative lens. The lens surface of the fourth lens L4 on the object-Ob-to-be-observed side is formed as an aspherical surface.

The fifth lens L5 is a biconvex positive lens.

The sixth lens L6 is a biconvex positive lens. The lens surfaces on the opposite sides of the sixth lens L6 are formed as aspherical surfaces.

The diopter is adjusted by the first lens L1 to the sixth lens L6 integrally moving on the optical axis.

In the present example, the second lens L2 constitutes the first positive lens Lp1, and the fifth lens L5 constitutes the second positive lens Lp2. The fourth lens L4 constitutes the first negative lens Ln1, and the third lens L3 constitutes the second negative lens Ln2. The first lens L1 constitutes the lens La that has an inflection point on an aspherical surface. The lens disposed closest to the object to be observed is the first lens L1, and the lens disposed closest to the eye point is the sixth lens L6.

The following Table 3 shows values of data in Third Example. Surface Number in Table 3 corresponds to each optical surface in FIG. 5. In Third Example, the first surface, second surface, fifth surface, seventh surface, eleventh surface, and twelfth surface are formed to have aspherical shapes.

TABLE 3
[General Data]

| | |
|---|---|
| fe = 18.131 | TL = 34.466 |
| ΣD = 27.290 | ΣDair = 3.990 |
| Daspe = 0.000 | Daspo = 0.000 |
| Np1 = 1.883 | Np2 = 1.845 |
| Nn1 = 1.636 | Nn2 = 1.636 |
| fLp1 = 20.863 | fLp2 = 23.385 |
| νp1 = 40.69 | νp2 = 43.79 |
| νn1 = 23.89 | |

[Lens Data]

| Surface | | | | |
|---|---|---|---|---|
| number | r | D | νd | nd |
| | ∞ | D0 | | |
| *1 | 25.4960 | 3.790 | 55.71 | 1.535037 |
| *2 | −46.9438 | 0.100 | | |
| 3 | 56.3221 | 6.760 | 40.69 | 1.883000 |
| 4 | −25.8347 | 2.910 | | |
| *5 | −9.8865 | 1.500 | 23.89 | 1.635500 |
| 6 | −25.4576 | 0.780 | | |
| *7 | −21.2835 | 1.500 | 23.89 | 1.635500 |
| 8 | 64.5917 | 0.100 | | |
| 9 | 48.6079 | 6.750 | 43.79 | 1.848500 |
| 10 | −31.3922 | 0.100 | | |
| *11 | 21.8356 | 3.000 | 55.71 | 1.535037 |
| *12 | −590.5452 | De | | |
| EP | | | | |

[Aspherical surface data]
1st surface
K = 1.0000, A4 = −1.10743E−04, A6 = 6.01836E−07, A8 = −2.17619E−09
2nd surface
K = 1.0000, A4 = −1.10097E−05, A6 = 2.55575E−07, A8 = 0.00000E+00
5th surface
K = 0.3380, A4 = 1.50503E−04, A6 = −2.10439E−07, A8 = 7.91597E−10
7th surface
K = 1.0000, A4 = 7. 74802E−06, A6 = −2.58880E−08, A8 = 0.00000E+00
11th surface
K = 1.0000, A4 = −5.30790E−05, A6 = 2.68087E−07, A8 = −8.14673E−10
12th surface
K = 1.0000, A4 = 6.21114E−05, A6 = 6.22836E−08, A8 = 0.00000E+00
[Variable distance data]

| diopter | −1[m⁻¹] | 0[m⁻¹] | −4[m⁻¹] | +2[m⁻¹] |
|---|---|---|---|---|
| D0 | 6.8407 | 7.1763 | 5.7449 | 7.8080 |
| De | 24.0000 | 23.5710 | 25.2790 | 22.7810 |

[Lens group data]

| | |
|---|---|
| f1 | 31.454 |
| f2 | 20.863 |
| f3 | −26.424 |
| f4 | −25.021 |
| f5 | 23.385 |
| f6 | 39.424 |

The table of data listed in Table 3 shows that the eyepiece optical system EL3 according to Third Example satisfies the conditional expressions (1) to (21).

FIG. 6 illustrates graphs showing various aberrations (spherical aberration, astigmatism, coma aberration, distortion, and chromatic aberration of magnification) of the eyepiece optical system EL3 according to Third Example with a diopter of −1 [m⁻¹].

As is evident from each aberration graph shown in FIG. 6, it is shown that with the eyepiece optical system EL3 according to Third Example, various aberrations, in particular, astigmatism and distortion, are favorably corrected, and the excellent optical performance is ensured.

### Fourth Example

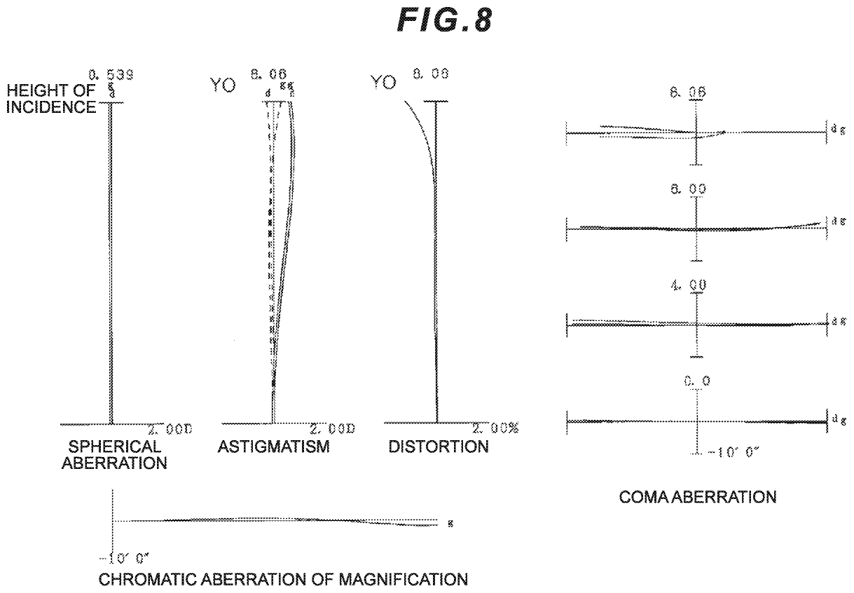

Fourth Example is described with reference to FIGS. 7 and 8, and Table 4. As shown in FIG. 7, an eyepiece optical system EL (EL4) according to Fourth Example includes, in order from an object to be observed (image display element) Ob on the optical axis: a first lens L1 that has positive refractive power; a cemented lens of a second lens L2 having negative refractive power and a third lens L3 having positive refractive power; a fourth lens that has negative refractive power; a fifth lens that has positive refractive power; and a sixth lens that has positive refractive power.

The first lens L1 is a biconvex positive lens. The lens surface of the first lens on the object-Ob-to-be-observed side is formed as an aspherical surface. On each aspherical surface, an inflection point at which the curvature changes from positive to negative or negative to positive is provided at a peripheral portion in the effective diameter.

The second lens L2 is a biconcave negative lens. The second lens L2 is cemented to the third lens L3.

The third lens L3 is a biconvex positive lens. The third lens L3 is cemented to the second lens L2.

The fourth lens L4 is a biconcave negative lens. The lens surface of the fourth lens L4 on the object-Ob-to-be-observed side is formed as an aspherical surface.

The fifth lens L5 is a biconvex positive lens.

The sixth lens L6 is a biconvex positive lens. The lens surface of the sixth lens L6 on the eye point side is formed as an aspherical surface.

The diopter is adjusted by the first lens L1 to the sixth lens L6 integrally moving on the optical axis.

In the present example, the third lens L3 constitutes the first positive lens Lp1, and the fifth lens L5 constitutes the second positive lens Lp2. The fourth lens L4 constitutes the first negative lens Ln1, and the second lens L2 constitutes the second negative lens Ln2. The first lens L1 constitutes the lens La that has an inflection point on an aspherical surface. The lens disposed closest to the object to be observed is the first lens L1, and the lens disposed closest to the eye point is the sixth lens L6.

The following Table 4 shows values of data in Fourth Example. Surface Number in Table 4 corresponds to each optical surface in FIG. 7. In Fourth Example, the first surface, sixth surface, and eleventh surface are formed to have aspherical shapes.

TABLE 4
[General Data]

| | |
|---|---|
| fe = 18.198 | TL = 37.270 |
| ΣD = 31.971 | ΣDair = 3.579 |
| Daspe = 0.000 | Daspo = 0.000 |
| Np1 = 1.883 | Np2 = 1.849 |
| Nn1 = 1.636 | Nn2 = 1.593 |
| fLp1 = 14.698 | fLp2 = 24.181 |
| νp1 = 40.69 | νp2 = 43.79 |
| νn1 = 23.89 | |

[Lens Data]

| Surface | | | | |
|---|---|---|---|---|
| number | r | D | νd | nd |
| | ∞ | D0 | | |
| *1 | 45.1873 | 3.779 | 55.71 | 1.535037 |
| 2 | −17.2217 | 0.100 | | |
| 3 | −24.4573 | 1.000 | 35.27 | 1.592700 |
| 4 | 24.4824 | 7.792 | 40.69 | 1.883000 |
| 5 | −23.4984 | 3.293 | | |
| *6 | −10.3072 | 1.200 | 23.89 | 1.635500 |
| 7 | 294.0016 | 0.100 | | |
| 8 | 113.3836 | 6.409 | 43.79 | 1.848500 |
| 9 | −24.4012 | 0.086 | | |
| 10 | 66.5141 | 3.711 | 57.47 | 1.491755 |
| *11 | −26.6992 | De | | |
| EP | | | | |

[Aspherical surface data]
1st surface
K = 1.0000, A4 = −1.55680E−04, A6 = 6.56284E−07, A8 = −7. 93249E−09
6th surface
K = 0.4463, A4 = 5.64814E−05, A6 = 2.63205E−07, A8 = −8.15805E−10
11th surface
K = 1.0000, A4 = 6.89637E−05, A6 = −7.02689E−08, A8 = 6.89253E−11
[Variable distance data]

| diopter | −1[m⁻¹] | 0[m⁻¹] | −4[m⁻¹] | +2[m⁻¹] |
|---|---|---|---|---|
| D0 | 4.626 | 5.2994 | 3.8799 | 5.9404 |
| De | 24.0000 | 23.7790 | 24.8600 | 23.4050 |

[Lens group data]

| | |
|---|---|
| f1 | 23.808 |
| f2 | −20.487 |
| f3 | 14.698 |
| f4 | −15.646 |
| f5 | 24.181 |
| f6 | 39.258 |

The table of data listed in Table 4 shows that the eyepiece optical system EL4 according to Fourth Example satisfies the conditional expressions (1) to (21).

FIG. 8 illustrates graphs showing various aberrations (spherical aberration, astigmatism, coma aberration, distortion, and chromatic aberration of magnification) of the eyepiece optical system EL4 according to Fourth Example with a diopter of −1 [m⁻¹].

As is evident from each aberration graph shown in FIG. 8, it is shown that with the eyepiece optical system EL4 according to Fourth Example, various aberrations, in particular, astigmatism and distortion, are favorably corrected, and the excellent optical performance is ensured.

### Fifth Example

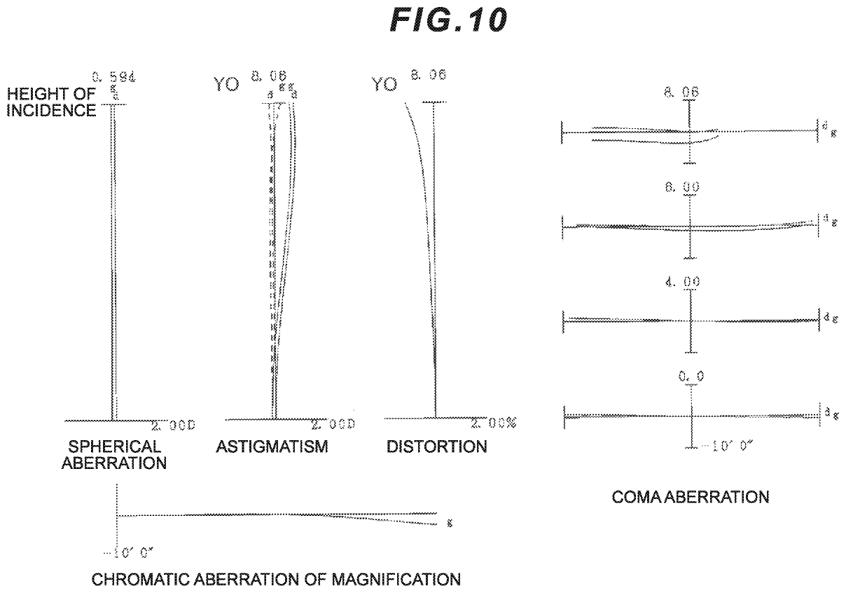

Fifth Example is described with reference to FIGS. 9 and 10, and Table 5. As shown in FIG. 9, an eyepiece optical system EL (EL5) according to Fifth Example includes, in order from an object to be observed (image display element) Ob on the optical axis: a first lens L1 that has positive refractive power; a cemented lens of a second lens L2 having negative refractive power and a third lens L3 having positive refractive power; a fourth lens that has negative refractive power; a fifth lens that has positive refractive power; and a sixth lens that has positive refractive power.

The first lens L1 is a biconvex positive lens. The lens surface of the first lens on the object-Ob-to-be-observed side is formed as an aspherical surface. On each aspherical surface, an inflection point at which the curvature changes from positive to negative or negative to positive is provided at a peripheral portion in the effective diameter.

The second lens L2 is a biconcave negative lens. The second lens L2 is cemented to the third lens L3.

The third lens L3 is a biconvex positive lens. The third lens L3 is cemented to the second lens L2.

The fourth lens L4 is a biconcave negative lens. The lens surface of the fourth lens L4 on the object-Ob-to-be-observed side is formed as an aspherical surface.

The fifth lens L5 is a biconvex positive lens.

The sixth lens L6 is a biconvex positive lens. The lens surfaces on the opposite sides of the sixth lens L6 are formed as aspherical surfaces.

The diopter is adjusted by the first lens L1 to the sixth lens L6 integrally moving on the optical axis.

In the present example, the third lens L3 constitutes the first positive lens Lp1, and the fifth lens L5 constitutes the second positive lens Lp2. The fourth lens L4 constitutes the first negative lens Ln1, and the second lens L2 constitutes the second negative lens Ln2. The first lens L1 constitutes the lens La that has an inflection point on an aspherical surface. The lens disposed closest to the object to be observed is the first lens L1, and the lens disposed closest to the eye point is the sixth lens L6.

The following Table 5 shows values of data in Fifth Example. Surface Number in Table 5 corresponds to each optical surface in FIG. 9. In Fifth Example, the first surface, sixth surface, tenth surface, and eleventh surface are formed to have aspherical shapes.

TABLE 5
[General Data]

| | |
|---|---|
| fe = 18.187 | TL = 33.143 |
| ΣD = 27.340 | ΣDair = 3.512 |
| Daspe = 0.000 | Daspo = 0.000 |
| Np1 = 1.883 | Np2 = 1.849 |
| Nn1 = 1.636 | Nn2 = 1.593 |
| fLp1 = 14.089 | fLp2 = 22.186 |
| νp1 = 40.69 | νp2 = 43.79 |
| νn1 = 23.89 | |

[Lens Data]

| Surface | | | | |
|---|---|---|---|---|
| number | r | D | νd | nd |
| | ∞ | D0 | | |
| *1 | 40.8779 | 3.070 | 55.71 | 1.535037 |
| 2 | −24.4309 | 0.100 | | |
| 3 | −39.6584 | 1.000 | 35.27 | 1.592700 |
| 4 | 21.0259 | 8.341 | 40.69 | 1.883000 |
| 5 | −24.7995 | 3.215 | | |
| *6 | −10.4525 | 1.200 | 23.89 | 1.635500 |
| 7 | 86.7881 | 0.100 | | |
| 8 | 55.0069 | 6.837 | 43.79 | 1.848500 |
| 9 | −26.9863 | 0.097 | | |
| *10 | 65.5311 | 3.380 | 57.47 | 1.491755 |
| *11 | −27.2455 | De | | |
| EP | | | | |

[Aspherical surface data]
1st surface
K = 1.0000, A4 = −1.42982E−04, A6 = 4.09497E−07, A8 = −4.87892E−09
6th surface
K = 0.4467, A4 = 1.02764E−04, A6 = −1.82925E−07, A8 = 6.56706E−10
10th surface
K = 1.0000, A4 = −8.63268E−05, A6 = 1.81967E−07, A8 = 0.00000E+00
11th surface
K = 1.0000, A4 = 1.24474E−05, A6 = −4.20778E−08, A8 = 4.75928E−10
[Variable distance data]

| diopter | −1[m⁻¹] | 0[m⁻¹] | −4[m⁻¹] | +2[m⁻¹] |
|---|---|---|---|---|
| D0 | 5.4662 | 5.8028 | 4.3814 | 6.4422 |
| De | 24.0000 | 23.7520 | 24.9640 | 23.3320 |

[Lens group data]

| | |
|---|---|
| f1 | 29.057 |
| f2 | −23.042 |
| f3 | 14.089 |
| f4 | −14.610 |
| f5 | 22.186 |
| f6 | 39.610 |

The table of data listed in Table 5 shows that the eyepiece optical system EL5 according to Fifth Example satisfies the conditional expressions (1) to (21).

FIG. 10 illustrates graphs showing various aberrations (spherical aberration, astigmatism, coma aberration, distortion, and chromatic aberration of magnification) of the eyepiece optical system EL5 according to Fifth Example with a diopter of −1 [m⁻¹].

As is evident from each aberration graph shown in FIG. 10, it is shown that with the eyepiece optical system EL5 according to Fifth Example, various aberrations, in particular, astigmatism and distortion, are favorably corrected, and the excellent optical performance is ensured.

### Sixth Example

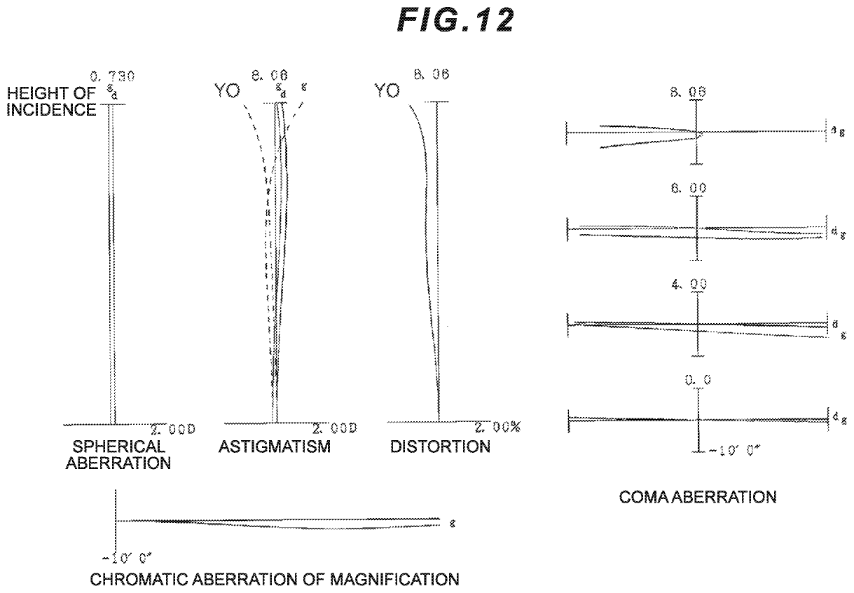

Sixth Example is described with reference to FIGS. 11 and 12, and Table 6. As shown in FIG. 11, an eyepiece optical system EL (EL6) according to Sixth Example includes, in order from an object to be observed (image display element) Ob on the optical axis: a first lens L1 that has positive refractive power; a second lens L2 that has positive refractive power; a third lens L3 that has negative refractive power; a fourth lens that has negative refractive power; a fifth lens that has positive refractive power; and a sixth lens that has positive refractive power.

The first lens L1 is a biconvex positive lens. The lens surfaces on the opposite sides of the first lens L1 are formed as aspherical surfaces. On each aspherical surface, an inflection point at which the curvature changes from positive to negative or negative to positive is provided at a peripheral portion in the effective diameter.

The second lens L2 is a meniscus-shaped positive lens having a concave surface facing the object Ob to be observed.

The third lens L3 is a meniscus-shaped negative lens having a concave surface facing the object Ob to be observed. The lens surface of the third lens L3 on the object-Ob-to-be-observed side is formed as an aspherical surface.

The fourth lens L4 is a biconcave negative lens. The lens surface of the fourth lens L4 on the object-Ob-to-be-observed side is formed as an aspherical surface.

The fifth lens L5 is a biconvex positive lens.

The sixth lens L6 is a meniscus-shaped positive lens having a convex surface facing the object Ob to be observed. The lens surface of the sixth lens L6 on the object-Ob-to-be-observed side is formed as an aspherical surface.

The diopter is adjusted by the first lens L1 to the sixth lens L6 integrally moving on the optical axis.

In the present example, the fifth lens L5 constitutes the first positive lens Lp1, and the second lens L2 constitutes the second positive lens Lp2. The third lens L3 constitutes the first negative lens Ln1, and the fourth lens L4 constitutes the second negative lens Ln2. The first lens L1 constitutes the lens La that has an inflection point on an aspherical surface. The lens disposed closest to the object to be observed is the first lens L1, and the lens disposed closest to the eye point is the sixth lens L6.

The following Table 6 shows values of data in Sixth Example. Surface Number in Table 6 corresponds to each optical surface in FIG. 11. In Sixth Example, the first surface, second surface, fifth surface, seventh surface, and eleventh surface are formed to have aspherical shapes.

TABLE 6
[General Data]

| | |
|---|---|
| fe = 18.187 | TL = 34.863 |
| ΣD = 27.814 | ΣDair = 2.774 |
| Daspe = 3.095 | Daspo = 0.000 |
| Np1 = 1.883 | Np2 = 1.883 |
| Nn1 = 1.636 | Nn2 = 1.636 |
| fLp1 = 17.100 | fLp2 = 22.156 |
| νp1 = 40.69 | νp2 = 40.69 |
| νn1 = 23.89 | |

[Lens Data]

| Surface | | | | |
|---|---|---|---|---|
| number | r | D | νd | nd |
| | ∞ | D0 | | |
| *1 | 30.7427 | 3.453 | 55.71 | 1.535037 |
| *2 | −21.6928 | 0.111 | | |
| 3 | −80.0537 | 6.330 | 40.69 | 1.883000 |
| 4 | −16.3046 | 2.116 | | |
| *5 | −9.0760 | 1.500 | 23.89 | 1.635500 |
| 6 | −44.0136 | 0.355 | | |
| *7 | −32.7012 | 1.500 | 23.89 | 1.635500 |
| 8 | 29.8046 | 0.092 | | |
| 9 | 30.5565 | 9.162 | 40.69 | 1.883000 |
| 10 | −25.6532 | 0.100 | | |
| *11 | 24.8745 | 3.095 | 54.89 | 1.677980 |
| 12 | 53.8481 | De | | |
| EP | | | | |

[Aspherical surface data]
1st surface
K = 1.0000, A4 = −2.33343E−04, A6 = 1.14278E−06, A8 = −7.74211E−09
2nd surface
K = 1.0000, A4 = −7.24654E−06, A6 = 5.95864E−07, A8 = 0.00000E+00
5th surface
K−0.4165, A4 = 2.12201E−04, A6 = −5.54425E−07, A8 = 2.60677E−09
7th surface
K = 0.1799, A4 = 1.23209E−05, A6 = −1.63134E−08, A8 = 0.00000E+00
11th surface
K = 1.0000, A4 = −7.22449E−05, A6 = 9.01971E−08, A8 = −1.60593E−10
[Variable distance data]

| diopter | −1[m⁻¹] | 0[m⁻¹] | −4[m⁻¹] | +2[m⁻¹] |
|---|---|---|---|---|
| D0 | 6.7120 | 7.0486 | 5.6270 | 7.6879 |
| De | 24.0000 | 23.7770 | 24.8540 | 23.3980 |

[Lens group data]

| | |
|---|---|
| f1 | 24.329 |
| f2 | 22.156 |
| f3 | −18.297 |
| f4 | −24.310 |
| f5 | 17.100 |
| f6 | 65.366 |

The table of data listed in Table 6 shows that the eyepiece optical system EL6 according to Sixth Example satisfies the conditional expressions (1) to (21).

FIG. 12 illustrates graphs showing various aberrations (spherical aberration, astigmatism, coma aberration, distortion, and chromatic aberration of magnification) of the eyepiece optical system EL6 according to Sixth Example with a diopter of −1 [m⁻¹].

As is evident from each aberration graph shown in FIG. 12, it is shown that with the eyepiece optical system EL6 according to Sixth Example, various aberrations, in particular, astigmatism and distortion, are favorably corrected, and the excellent optical performance is ensured.

### Seventh Example

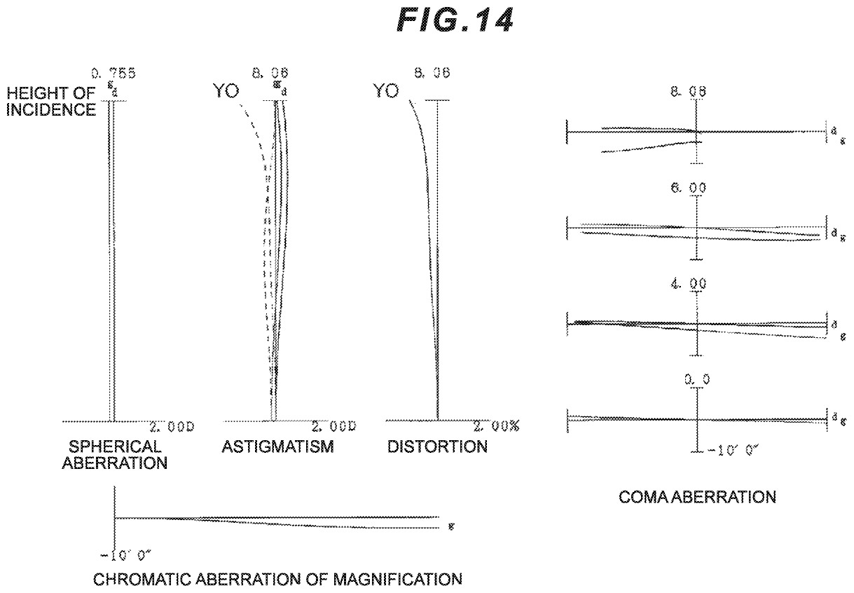

Seventh Example is described with reference to FIGS. 13 and 14, and Table 7. As shown in FIG. 13, an eyepiece optical system EL (EL7) according to Seventh Example includes, in order from an object to be observed (image display element) Ob on the optical axis: a first lens L1 that has positive refractive power; a second lens L2 that has positive refractive power; a third lens L3 that has negative refractive power; a fourth lens that has positive refractive power; and a fifth lens that has positive refractive power.

The first lens L1 is a biconvex positive lens. The lens surfaces on the opposite sides of the first lens L1 are formed as aspherical surfaces. On each aspherical surface, an inflection point at which the curvature changes from positive to negative or negative to positive is provided at a peripheral portion in the effective diameter.

The second lens L2 is a meniscus-shaped positive lens having a concave surface facing the object Ob to be observed.

The third lens L3 is a biconcave negative lens. The lens surface of the third lens L3 on the object-Ob-to-be-observed side is formed as an aspherical surface.

The fourth lens L4 is a biconvex positive lens.

The fifth lens L5 is a meniscus-shaped positive lens having a convex surface facing the object Ob to be observed. The lens surfaces on the opposite sides of the fifth lens L5 are formed as aspherical surfaces.

The diopter is adjusted by the first lens L1 to the fifth lens L5 integrally moving on the optical axis.

In the present example, the fourth lens L4 constitutes the first positive lens Lp1, and the second lens L2 constitutes the second positive lens Lp2. The third lens L3 constitutes the first negative lens Ln1. The first lens L1 constitutes the lens La that has an inflection point on an aspherical surface. The lens disposed closest to the object to be observed is the first lens L1, and the lens disposed closest to the eye point is the fifth lens L5.

The following Table 7 shows values of data in Seventh Example. Surface Number in Table 7 corresponds to each optical surface in FIG. 13. In Seventh Example, the first surface, second surface, fifth surface, ninth surface, and tenth surface are formed to have aspherical shapes.

TABLE 7
[General Data]

| | |
|---|---|
| fe = 18.213 | TL = 32.984 |
| ΣD = 25.703 | ΣDair = 2.748 |
| Daspe = 0.000 | Daspo = 0.000 |
| Np1 = 1.883 | Np2 = 1.883 |
| Nn1 = 1.636 | |
| fLp1 = 16.698 | fLp2 = 21.275 |
| νp1 = 40.69 | νp2 = 40.69 |
| νn1 = 23.89 | |

[Lens Data]

| Surface | | | | |
|---|---|---|---|---|
| number | r | D | νd | nd |
| | ∞ | D0 | | |
| *1 | 32.7975 | 3.029 | 55.71 | 1.535037 |
| *2 | −24.3942 | 0.494 | | |
| 3 | −87.3421 | 6.489 | 40.69 | 1.883000 |
| 4 | −15.9994 | 2.048 | | |
| *5 | −8.9544 | 3.025 | 23.89 | 1.635500 |
| 6 | 27.9672 | 0.106 | | |
| 7 | 28.7752 | 8.711 | 40.69 | 1.883000 |
| 8 | −25.9469 | 0.100 | | |
| *9 | 32.5952 | 1.701 | 55.71 | 1.535037 |
| *10 | 184.2753 | De | | |
| EP | | | | |

[Aspherical surface data]
1st surface
K = 1.0000, A4 = −1.90801E−04, A6 = 8.52594E−07, A8 = −8.21187E−09
2nd surface
K = 1.0000, A4 = 5.30258E−06, A6 = 5.64950E−07, A8 = 0.00000E+00
5th surface
K = 0.3570, A4 = 1.86033E−04, A6 = −3.54122E−07, A8 = 1.51527E−09
9th surface
K = 1.0000, A4 = −4.83443E−05, A6 = 2.31752E−07, A8 = −4.78017E−10
10th surface
K = 1.0000, A4 = 4.54289E−05, A6 = 5.96479E−08, A8 = 0.00000E+00
[Variable distance data]

| diopter | −1[m⁻¹] | 0[m⁻¹] | −4[m⁻¹] | +2[m⁻¹] |
|---|---|---|---|---|
| D0 | 6.9448 | 7.2819 | 5.8648 | 7.9248 |
| De | 24.0000 | 23.8000 | 24.7560 | 23.4570 |

[Lens group data]

| | |
|---|---|
| f1 | 26.638 |
| f2 | 21.275 |
| f3 | −10.348 |
| f4 | 16.698 |
| f5 | 73.725 |

The table of data listed in Table 7 shows that the eyepiece optical system EL7 according to Seventh Example satisfies the conditional expressions (1) to (7), and (9) to (19).

FIG. 14 illustrates graphs showing various aberrations (spherical aberration, astigmatism, coma aberration, distortion, and chromatic aberration of magnification) of the eyepiece optical system EL7 according to Seventh Example with a diopter of −1 [m⁻¹].

As is evident from each aberration graph shown in FIG. 14, it is shown that with the eyepiece optical system EL7 according to Seventh Example, various aberrations, in particular, astigmatism and distortion, are favorably corrected, and the excellent optical performance is ensured.

Next, the table of [Conditional Expression Corresponding Value] is shown below. This table collectively lists values corresponding to the conditional expressions (1) to (21) with respect to all the examples (First to Seventh Examples).

$$1.7 < Np 1 < 2.05 \qquad Conditional expression ( 1 )$$

$$1.7 < Np 2 < 2.05 \qquad Conditional expression ( 2 )$$

$$0.9 < Np 2 / Np 1 < 1.1 \qquad Conditional expression ( 3 )$$

$$0.7 < fLp 1 / fe < 1.3 \qquad Conditional expression ( 4 )$$

$$0.9 < fLp 2 / fe < 1.7 \qquad Conditional expression ( 5 )$$

$$1.5 < Nn 1 < 1.7 \qquad Conditional expression ( 6 )$$

$$16. < ν n 1 < 36. \qquad Conditional expression ( 7 )$$

$$1.5 < Nn 2 < 1.7 \qquad Conditional expression ( 8 )$$

$$8. < ν p 1 - ν n 1 < 35. \qquad Conditional expression ( 9 )$$

$$8. < ν p 2 - ν n 1 < 35. \qquad Conditional expression ( 10 )$$

$$0.4 < h / fe < 0.5 \qquad Conditional expression ( 11 )$$

$$0. \leq Daspe / \sum D < 0.2 \qquad Conditional expression ( 12 )$$

$$0. \leq Daspo / \sum D < 0.2 \qquad Conditional expression ( 13 )$$

$$0.2 < y / Ry < 0.85 \qquad Conditional expression ( 14 )$$

$$20. [ mm ] < De < 30. [ mm ] \qquad Conditional expression ( 15 )$$

$$1.1 < De / fe < 1.5 \qquad Conditional expression ( 16 )$$

$$0.25 < D 0 / fe < 0.5 \qquad Conditional expression ( 17 )$$

$$0.12 < D 0 / TL < 0.25 \qquad Conditional expression ( 18 )$$

$$0.08 < \sum Dair / \sum D < 0.2 \qquad Conditional expression ( 18 )$$

$$1. < f 1 / fe < 2.5 \qquad Conditional expression ( 19 )$$

$$1.5 < fep / fe < 5. \qquad Conditional expression ( 20 )$$

### [Conditional Expression Corresponding Value] (First to Seventh Example)

TABLE 8

| Conditional | First | Second | Third | Fourth | Fifth | Sixth | Seventh |
|---|---|---|---|---|---|---|---|
| Expression | example | example | example | example | example | example | example |
| (1) | 1.883 | 1.816 | 1.883 | 1.883 | 1.883 | 1.883 | 1.883 |
| (2) | 1.883 | 1.816 | 1.845 | 1.849 | 1.849 | 1.883 | 1.883 |
| (3) | 1.000 | 1.000 | 0.980 | 0.982 | 0.982 | 1.000 | 1.000 |
| (4) | 0.957 | 1.128 | 1.151 | 0.808 | 0.775 | 0.940 | 0.917 |
| (5) | 1.165 | 1.522 | 1.290 | 1.329 | 1.220 | 1.218 | 1.168 |
| (6) | 1.636 | 1.636 | 1.636 | 1.636 | 1.636 | 1.636 | 1.636 |
| (7) | 23.890 | 23.890 | 23.890 | 23.890 | 23.890 | 23.890 | 23.890 |
| (8) | 1.636 | 1.636 | 1.636 | 1.593 | 1.593 | 1.636 | — |
| (9) | 16.800 | 22.700 | 16.800 | 16.800 | 16.800 | 16.800 | 16.800 |
| (10) | 16.800 | 22.700 | 19.900 | 19.900 | 19.900 | 16.800 | 16.800 |
| (11) | 0.445 | 0.446 | 0.446 | 0.445 | 0.445 | 0.445 | 0.444 |
| (12) | 0.000 | 0.158 | 0.000 | 0.000 | 0.000 | 0.111 | 0.000 |
| (13) | 0.000 | 0.000 | 0.000 | 0.000 | 0.000 | 0.000 | 0.000 |
| (14) | 0.372 | 0.321 | 0.677 | 0.350 | 0.369 | 0.324 | 0.358 |
| (15) | 24.000 | 24.000 | 24.000 | 24.000 | 24.000 | 24.000 | 24.000 |
| (16) | 1.318 | 1.322 | 1.324 | 1.319 | 1.320 | 1.320 | 1.318 |
| (17) | 0.408 | 0.346 | 0.396 | 0.291 | 0.319 | 0.388 | 0.400 |
| (18) | 0.225 | 0.175 | 0.208 | 0.142 | 0.175 | 0.202 | 0.221 |
| (19) | 0.107 | 0.160 | 0.146 | 0.112 | 0.128 | 0.100 | 0.107 |
| (20) | 1.416 | 1.931 | 1.735 | 1.308 | 1.598 | 1.338 | 1.463 |
| (21) | 3.470 | 1.707 | 2.174 | 2.157 | 2.178 | 3.594 | 4.048 |

As described above, according to the present invention, even with high finder magnification, the eyepiece optical system having favorably corrected various aberrations (in particular, astigmatism and distortion) can be achieved.

To facilitate understanding of the present invention, the description is made with the configuration requirements of the embodiments, but it is a matter of course that the present invention is not limited thereto. The content described below can be employed as appropriate in a range without degrading the optical performance.

The lens surface may be formed as a spherical surface or a flat surface, or formed as an aspherical surface. The case where the lens surface is a spherical surface or a flat surface is preferable because lens processing and assembly adjustment are facilitated, and the degradation of optical performance due to processing and assembly adjustment errors can be prevented. It is also preferable because the degradation of the imaging performance is small even if the image surface deviates. In the case where the lens surface is an aspherical surface, the aspherical surface may be any aspherical surface among an aspherical surface by a grinding process, a glass-molded aspherical surface achieved by molding glass to have an aspherical surface shape, and a composite type aspherical surface achieved by forming resin to have an aspherical surface on the surface of glass. The lens surface may be a diffraction surface, and the lens may be a graded-index lens (GRIN lens) or a plastic lens.

To reduce flares and ghosting and achieve high optical performance with high contrast, antireflection coating that has high transmittance over a wide wavelength range may be applied on each lens surface.

### EXPLANATION OF NUMERALS AND CHARACTERS

CAM Digital camera (optical apparatus)
OL Objective lens
C Image sensor
Ob Image display element (object to be observed)
EL (EL1 to EL7) Eyepiece optical system
L1 First lens
L2 Second lens
L3 Third lens
L4 Fourth lens
L5 Fifth lens
L6 Sixth lens
EP Eye point

1. An eyepiece optical system, comprising: a first positive lens that has positive refractive power; and a second positive lens that has positive refractive power, wherein the following conditional expressions are satisfied,
$$1.7 < Np 1 < 2.05 , and$$
$$1.7 < Np 2 < 2.05 ,$$
where Np1: a refractive index of the first positive lens with respect to d-line, and
Np2: a refractive index of the second positive lens with respect to d-line.

2. An eyepiece optical system, comprising at least five lenses, wherein the following conditional expression is satisfied,
$$0.4 < h / fe < 0.5 ,$$
where fe: a combined focal length of the eyepiece optical system, and
h: a maximum object height of an object to be observed for the eyepiece optical system.

3. The eyepiece optical system according to claim 1, wherein the first positive lens has a highest positive refractive power in the eyepiece optical system, and the following conditional expression is satisfied,
$$0.9 < Np 2 / Np 1 < 1.1 0 .$$

4. The eyepiece optical system according to claim 1, wherein the first positive lens has a highest positive refractive power in the eyepiece optical system, and the following conditional expression is satisfied,
$$0.7 < fLp 1 / fe < 1.3 ,$$
where fLp1: a focal length of the first positive lens, and
fe: a combined focal length of the eyepiece optical system.

5. The eyepiece optical system according to claim 1, wherein the second positive lens has a second-highest positive refractive power in the eyepiece optical system, and the following conditional expression is satisfied,
$$0. 90 < fLp 2 / fe < 1.7 ,$$
where fLp2: a focal length of the second positive lens, and
fe: a combined focal length of the eyepiece optical system.

6. The eyepiece optical system according to claim 1, further comprising a first negative lens that has a highest negative refractive power in the eyepiece optical system, wherein the following conditional expressions are satisfied,
$$1. 5 \; 00 < Nn 1 < 1.7 , and$$
$$1.6 < ν n 1 < 36. ,$$
where Nn1: a refractive index of the first negative lens with respect to d-line, and
νn1: an Abbe number of the first negative lens with reference to d-line.

7. The eyepiece optical system according to claim 1, further comprising a second negative lens that has a second-highest negative refractive power in the eyepiece optical system, wherein the following conditional expression is satisfied,
$$1. 5 \; 00 < Nn 2 < 1.7 ,$$
where Nn2: a refractive index of the second negative lens with respect to d-line.

8. The eyepiece optical system according to claim 6, wherein the following conditional expression is satisfied,
$$8. < ν p 1 - ν n 1 < 35. ,$$
where νp1: an Abbe number of the first positive lens with reference to d-line, and
νn1: an Abbe number of the first negative lens with reference to d-line.

9. The eyepiece optical system according to claim 6, wherein the following conditional expression is satisfied,
$$8. < ν p 2 - ν n 1 < 35. ,$$
where νp2: an Abbe number of the second positive lens with reference to d-line, and
νn1: an Abbe number of the first negative lens with reference to d-line.

10. The eyepiece optical system according to claim 1, wherein the following conditional expression is satisfied,
$$0.4 < h / fe < 0.5 ,$$
where fe: a combined focal length of the eyepiece optical system, and
h: a maximum object height of an object to be observed in the eyepiece optical system.

11. The eyepiece optical system according to claim 1, further comprising one or more lenses having lens surfaces on which aspherical surfaces are formed, wherein the following conditional expression is satisfied,
$$0. \leq Daspe / \sum D < 0.2 ,$$
where Daspe: a distance on an optical axis from an aspherical surface that is closest to an eye point among the aspherical surfaces to a lens surface of the eyepiece optical system that is closest to the eye point, and
ΣD: a distance on the optical axis from a lens surface that is closest to an object to be observed to the lens surface that is closest to the eye point.

12. The eyepiece optical system according to claim 1, further comprising one or more lenses having lens surfaces on which aspherical surfaces are formed, wherein the following conditional expression is satisfied,
$$0. 000 \leq D a spo / \sum D < 0.2 ,$$
where Daspo: a distance on an optical axis from a lens surface of the eyepiece optical system that is closest to an object to be observed to an aspherical surface that is closest to the object to be observed among the aspherical surfaces, and
ΣD: a distance on the optical axis from the lens surface that is closest to the object to be observed to the lens surface that is closest to an eye point.

13. The eyepiece optical system according to claim 1, further comprising at least one lens having a lens surface on which an aspherical surface is formed, the aspherical surface being provided with an inflection point at which a curvature is inverted from positive to negative or negative to positive, wherein the following conditional expression is satisfied,
$$0. 20 < y / Ry < 0.85 ,$$
where y: a distance between an optical axis of the lens and the inflection point in a direction perpendicular to the optical axis, and
Ry: a radius of the lens.

14. The eyepiece optical system according to claim 1, wherein the following conditional expression is satisfied,
$$20. [ mm ] < De < 30. [ mm ] ,$$
where De: a distance on an optical axis to an eye point from a lens surface of the eyepiece optical system that is closest to the eye point.

15. The eyepiece optical system according to claim 1, wherein the following conditional expression is satisfied,
$$1.1 < De / fe < 1.5 ,$$
where De: a distance on an optical axis to an eye point from a lens surface of the eyepiece optical system that is closest to the eye point, and
fe: a combined focal length of the eyepiece optical system.

16. The eyepiece optical system according to claim 1, wherein the following conditional expression is satisfied,
$$0. 250 < D 0 / fe < 0.5 ,$$
where D0: a distance on an optical axis from an object to be observed to a lens surface closest to the object to be observed, with a diopter of 0 [m⁻¹], and
fe: a combined focal length of the eyepiece optical system.

17. The eyepiece optical system according to claim 1, wherein the following conditional expression is satisfied,
$$0. 120 < D 0 / TL < 0.25 ,$$
where D0: a distance on an optical axis from an object to be observed to a lens surface closest to the object to be observed, with a diopter of 0 [m⁻¹], and
TL: a distance on the optical axis from the object to be observed to a lens surface closest to an eye point, with a diopter of 0 [m⁻¹].

18. The eyepiece optical system according to claim 1, wherein the following conditional expression is satisfied,
$$0. 0 \; 80 < \sum Dair / \sum D < 0 \text{.200} ,$$
where ΣDair: a sum of air distances between lenses from a lens closest to an object to be observed to a lens closest to an eye point, and
ΣD: a distance on the optical axis from a lens surface that is closest to the object to be observed to a lens surface that is closest to the eye point.

19. The eyepiece optical system according to claim 1, wherein the following conditional expression is satisfied,
$$1. < f 1 / fe < 2.5 ,$$
where f1: a focal length of a lens disposed closest to an object to be observed, and
fe: a combined focal length of the eyepiece optical system.

20. The eyepiece optical system according to claim 1, wherein the following conditional expression is satisfied,
$$1.5 < fep / fe < 5. ,$$
where fep: a focal length of a lens disposed closest to an eye point, and
fe: a combined focal length of the eyepiece optical system.

21. An optical apparatus, comprising: an objective lens; an image sensor that captures an image formed by the objective lens; an image display element that displays the image captured by the image sensor; and an eyepiece optical system for observing the image displayed on the image display element, wherein
the eyepiece optical system is the eyepiece optical system according to claim 1.
